(19) United States
(12) Patent Application Publication
(10) Pub. No.: US 2012/0122062 A1
(43) Pub. Date: May 17, 2012

(54) RECONFIGURABLE PLATFORM MANAGEMENT APPARATUS FOR VIRTUAL REALITY-BASED TRAINING SIMULATOR

(75) Inventors: Ung-Yeon YANG, Daejeon (KR); Gun A. LEE, Daejeon (KR); Yong-Wan KIM, Daejeon (KR); Dong-Sik JO, Daejeon (KR); Jin-Sung CHOI, Daejeon (KR); Ki-Hong KIM, Daejeon (KR)

(73) Assignee: Electronics and Telecommunications Research Institute, Daejeon-city (KR)

(21) Appl. No.: 13/293,234

(22) Filed: Nov. 10, 2011

(30) Foreign Application Priority Data
Nov. 16, 2010 (KR) 10-2010-0114090

(51) Int. Cl. G09B 19/00

(52) U.S. Cl. 434/219

(57) ABSTRACT

Disclosed herein is a reconfigurable platform management apparatus for a virtual reality-based training simulator, which enables a device platform to be reconfigured to suit various work environments and to fulfill various work scenario requirements of users. The reconfigurable platform management apparatus for a virtual reality-based training simulator includes an image output unit for outputting a stereoscopic image of mixed reality content that is used for work training of a user. A user working tool unit generates virtual sensation feedback corresponding to sensation feedback generated based on a user's motion to the outputted stereoscopic image when working with an actual working tool. A tracking unit transmits a sensing signal obtained by sensing a user's motion working tool unit to the image output unit and the user working tool unit.

### CROSS REFERENCE TO RELATED APPLICATION

This application claims the benefit of Korean Patent Application No. 10-2010-0114090, filed on Nov. 16, 2010, which is hereby incorporated by reference in its entirety into this application.

### BACKGROUND OF THE INVENTION

1. Technical Field

The present invention relates generally to a reconfigurable platform management apparatus for a virtual reality-based training simulator and, more particularly, to a reconfigurable platform management apparatus for a virtual reality-based training simulator, which suits various work environments and fulfills various user-centered requirements, and provides a virtual reality-based training simulator.

2. Description of the Related Art

Existing training methods using actual tools may be accompanied by a lot of difficulties such as the use of consumptive materials, a limited training space, problems related to the management of supplementary facilities, the risk of negligent accidents that injure beginners due to voltage, current, heat emission, and spatter (of flames), and passive coping with training. That is, highly experienced professionals are required in workplaces, but the problems enumerated above may act as obstructions to the performance of efficient training.

In order to solve these problems, virtual reality-based training simulators were developed which create a virtual environment identical to an actual work environment and which allow operators to be trained while minimizing difficulties occurring due to the above problems in the created virtual environment.

Such a virtual reality-based training simulator is a system in which education and training situations in the workplace are implemented using digital content based on real-time simulation, and which is provided with an input/output interface device for allowing a user to directly interact with the content, so that the user can be presented with the same experience that the user would obtain from the actual work environment. When this system is utilized, it is possible for the user to be trained using a procedure that obtains high economic effects, such as the reduction of training-related costs and negligent accidents, and that improves training efficiency. Accordingly, simulation systems corresponding to various situations, such as occur in the space, aeronautical, military, medical, educational and industrial fields, have been developed.

However, the conventional virtual reality-based training simulators have not yet presented various work scenarios that can flexibly cope with all the situations that occur in the workplace.

Accordingly, the conventional virtual reality-based training simulators are limited in that they do not fulfill the technical requirements of consumers who desire virtual training-based simulators capable of actively coping with a variety of workplaces and a variety of situations.

Examples of existing technology for virtual welding training include “Virtual Simulator Method and System for Neuromuscular Training and Certification via a Communication Network” of 123 Certification, Inc., and “Welding Simulator” of Samsung Heavy Industries Co., Ltd. and KAIST. However, these technologies are limited in that they cannot fulfill the technical requirements of consumers who desire to implement various work scenarios by flexibly coping with all situations in those workplaces, as will be described later when presenting objects of the present invention.

### SUMMARY OF THE INVENTION

Accordingly, the present invention has been made keeping in mind the above problems occurring in the prior art, and an object of the present invention is to provide a reconfigurable platform management apparatus for a virtual reality-based training simulator, which facilitates the movable operation of virtual reality-based training simulation content when operating the virtual reality-based training simulation content.

Another object of the present invention is to provide a reconfigurable platform management apparatus for a virtual reality-based training simulator, which enables a device platform to be reconfigured to suit various work environments and to fulfill various work scenario requirements of users.

A further object of the present invention is to provide a platform apparatus and method, which supplement a prior patent filed by the present applicant (disclosed in Korean Patent Application No. 10-2009-0125543 entitled “Reconfigurable Device Platform and Operating Method thereof for Virtual Reality-based Training Simulator”) and which reproduce a situation, in which a user experiences various training procedures with a specific tool in his or her hands, in a fully immersive virtual space, thus providing a virtual environment which maximizes efficiency in space management from the standpoint of system management in a workplace and which allows a user to be fully immersed in the virtual environment.

Yet another object of the present invention is to provide a platform apparatus and method, which additionally present in detail the case of a virtual welding training simulator as an embodiment of the present invention, thereby supporting various scenarios for welding postures that could not be solved by the conventional technology, and allowing a user to equally experience sensations (visual, aural, tactile and olfactory sensations, and the like) that can be felt in the actual workplace.

In accordance with an aspect of the present invention to accomplish the above objects, there is provided a reconfigurable platform management apparatus for a virtual reality-based training simulator, including an image output unit for outputting a stereoscopic image of mixed reality content that is used for work training of a user; a user working tool unit for generating virtual sensation feedback corresponding to sensation feedback generated based on a user's motion to the outputted stereoscopic image when working with an actual working tool; and a tracking unit for transmitting a sensing signal obtained by sensing a user's motion working tool unit to the image output unit and the user working tool unit.

Preferably, the image output unit may include a stereoscopic display unit for dividing the stereoscopic image of the mixed reality content into pieces of visual information for left and right eyes and outputting a resulting stereoscopic image; an information visualization unit for visualizing additional information and outputting the visualized additional information to the stereoscopic image output from the stereoscopic display unit; and a reconfigurable platform control unit for, based on the user physical information and mixed reality content currently being output, setting change information required to change structures of the stereoscopic display unit and the information visualization unit.

Preferably, the information visualization unit may include a mixed reality-based information visualization unit for visualizing the additional information and outputting visualized additional information to the stereoscopic image output from the stereoscopic display unit; and a Layered Multiple Display (LMD)-based information visualization unit for visualizing the additional information and outputting visualized additional information to outside of the stereoscopic image output from the stereoscopic display unit so that pieces of additional information differentiated for a plurality of users are provided to the respective users.

Preferably, the LMD-based information visualization unit may be implemented as a see-through type LMD-based display device used in augmented reality.

Preferably, the image output unit may include a sensor unit for sensing the user physical information; and a manual/automatic control unit for the changing structures of the stereoscopic display unit and the information visualization unit based on at least one of information input from a user interface unit, the change information input from the reconfigurable platform control unit, and the user physical information sensed by the sensor unit.

Preferably, the reconfigurable platform control unit may set change information such as height, rotation and distance of the stereoscopic display unit, based on the user physical information and the mixed reality content.

Preferably, the reconfigurable platform control unit may include a height and a ground pressure distribution of the user with reference values, generate change guidance information required to change a location of the image output unit, and transmit and outputs the generated change guidance information to a user interface unit.

Preferably, the reconfigurable platform control unit may include a height and a ground pressure distribution of the user with reference values, and then changes a location of the image output unit.

Preferably, the stereoscopic display unit may include a Liquid Crystal Display (LCD) flat stereoscopic image panel and a translucent mirror, and further include an optical retarder between the LCD flat stereoscopic image panel and the translucent mirror.

Preferably, the user working tool unit may include a working tool creation unit for creating a plurality of working tools used for a plurality of pieces of mixed reality content; and a working tool support unit for forming in each of the working tools and supporting feedback of multiple sensations depending on simulations of the pieces of mixed reality content.

Preferably, the working tool support unit may include a visual feedback support unit for outputting information that stimulates a visual sensation and transferring feedback information related to the working tool; a haptic feedback support unit for transferring effects of physical and cognitive forces; an acoustic feedback support unit for representing input/output information using sound effects; an olfactory feedback support unit for providing input/output of information using an olfactory organ; and a tracking support unit for exchanging location information and posture information of the working tool in conjunction with the tracking unit.

Preferably, the tracking unit may include a sensor-based tracking information generation unit for sensing at least one of location, posture, pressure, acceleration, and temperature of each of the user and the user working tool unit, and then tracking the user and the user working tool unit; a database(DB)-based tracking information generation unit for simulating a plurality of pieces of tracking data at regular time intervals, and generating input values which are values currently generated by sensors; and a virtual sensor-based tracking information generation unit for generating physically sensed values using the input values generated by the DB-based tracking information generation unit.

Preferably, the tracking unit may set a camera-based stable tracking space including installation locations and capturing directions of a plurality of cameras in order to track the user's motion.

Preferably, the reconfigurable platform management apparatus may further comprising the user interface unit may include a Graphic User Interface (GUI) manipulation unit for receiving preset values required to set system operation setup parameters and work scenario-related parameters, outputting the preset values, and transmitting the system operation setup parameters and the work scenario-related parameters to a content operation unit; and a simulator management control unit for transmitting posture change and guidance information of a reconfigurable hardware platform to the image output unit, based on conditions of a work scenario, and generating a control signal required to control the simulator.

Preferably, the user interface unit may receive preset values required to adjust parameters including at least one of a height and a rotation angle of the image output unit, based on the user physical information and the work scenario.

Preferably, the reconfigurable platform management apparatus may further include a content operation unit for managing a plurality of pieces of mixed reality content, detecting pieces of mixed reality content to be used for work training of the user from the plurality of pieces of mixed reality content, and providing the detected mixed reality content to the image output unit.

Preferably, the content operation unit may include a tracking data processing unit for receiving tracking information generated by a tracking target entity from the tracking unit and processing the tracking information; a real-time work simulation unit for simulating interaction with surrounding objects, based on a workplace scenario that utilizes the simulator; a real-time result rendering unit for rendering results of a simulation performed by the real-time work simulation unit, and transmitting and outputting rendered results to the image output unit; a user-centered reconfigurable platform control unit for processing situation information of the mixed reality content and the information of the simulator in association with each other, setting change information for the platform; a user interface control unit for transmitting the change information set by the user-centered reconfigurable platform control unit to the user interface unit; a network-based training DB for storing a plurality of pieces of mixed reality content corresponding to a plurality of work environments generated by a content generation unit; and a multi-sensation feedback control unit for generating multi-sensation feedback control signals based on the results of the simulation performed by the real-time work simulation unit and transmitting the multi-sensation feedback control signals to the user working tool unit.

Preferably, the reconfigurable platform management apparatus may further include a system management unit including an external observation content output unit for outputting progress of a simulation and results of the simulation to outside of the simulator; a system protection unit for performing installation and management of the system; a system disassembly and associative assembly support unit for providing movement of the system and simultaneous installation of a plurality of platforms; and a server-based system remote management unit for transmitting or receiving control information required to control at least one of initiation and termination of a remote control device and the system and setup of work conditions processed by the user interface unit.

Preferably, the reconfigurable platform management apparatus may further include a content generation unit for generating pieces of mixed reality content that are used for work training of the user.

Preferably, the content generation unit may include an actual object acquisition unit for receiving virtual object models from the user working tool unit, using any one of modeling of objects included in the mixed reality content and selection of stored objects, and then acquiring actual objects; a virtual object generation unit for generating virtual objects corresponding to the actual objects acquired by the actual object acquisition unit using either input images or an image-based modeling technique; an inter-object interactive scenario generation unit for generating scenarios related to the virtual objects generated by the virtual object generation unit; and a mixed reality content DB for storing the scenarios generated by the inter-object interactive scenario generation unit.

According to the present invention, the following advantages can be anticipated.

Costs required to construct a training system identical to an actual work environment and consumptive costs caused by the consumption of materials for training can be reduced by replacing objects by virtual reality data, thus obtaining economic advantages thanks to cost reduction.

In particular, in the case of a virtual welding training simulator presented as an embodiment of the present invention which will be described later, elements corresponding to various working structures, that is, a training space, work preparation time, and finishing work time after training, can be more efficiently utilized, and the risk of injuring beginners with negligent accidents can be greatly reduced, thus enabling the beginners to be trained to become experienced workers.

In addition, the present invention visualizes any workplace that requires an educational and training procedure on the basis of a real-time simulation, and thus the present invention can be widely used in all fields in which scenarios are executed by users' activity.

Furthermore, the present invention reproduces the training scenarios and user actions, corresponding to an actual situation, in a fully immersive virtual space based on real-time simulations, so that users can experience education and training identical to those of the actual situation, thus minimizing the problems of negligent accidents that may occur in the actual education and training procedure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a reconfigurable platform management apparatus for a virtual reality-based training simulator according to an embodiment of the present invention;

FIGS. 2 to 4 are diagrams showing the image output unit of FIG. 1;

FIGS. 5 and 6 are diagrams showing the user working tool unit of FIG. 1;

FIG. 7 is a diagram showing the tracking unit of FIG. 1;

FIG. 8 is a diagram showing the interface unit of FIG. 1;

FIG. 9 is a diagram showing the content operation unit of FIG. 1;

FIG. 10 is a diagram showing the system management unit of FIG. 1;

FIG. 11 is a diagram showing the content generation unit of FIG. 1;

FIG. 12 is a diagram illustrating the construction of an industrial virtual welding training simulator according to an embodiment of the present invention;

FIGS. 13 to 16 are diagrams showing the image output unit of FIG. 12;

FIG. 17 is a diagram showing the reconfigurable platform control unit of FIG. 13;

FIGS. 18 and 19 are diagrams showing the user working tool unit of FIG. 12;

FIG. 20 is a diagram showing the tracking unit of FIG. 12;

FIG. 21 is a diagram showing the content operation unit of FIG. 12;

FIG. 22 is a diagram showing the system management unit of FIG. 12;

FIG. 23 is a conceptual diagram showing the implementation of a virtual welding training simulator for an educational institution according to an embodiment of the present invention;

FIG. 24 is a conceptual diagram showing an FMD-based virtual welding training simulator according to an embodiment of the present invention;

FIG. 25 is a diagram showing an example of the utilization of the image output unit and the LMD-supporting FMD extension version of FIG. 24;

FIGS. 26 to 33 are conceptual diagrams showing the reconfigurable installation frame structure and the system management unit of the tracking unit of FIG. 24;

FIGS. 34 to 36 are diagrams showing a camera-based tracking unit for implementing an FMD-based virtual welding training simulator;

FIG. 37 is a conceptual diagram showing an example of the utilization of the web pad-based result evaluation and system remote management unit of FIG. 24; and

FIG. 38 is a diagram showing an example of a method of operating the FMD-based virtual welding training simulator and the installation of the simulator according to an embodiment of the present invention.

### DESCRIPTION OF THE PREFERRED EMBODIMENTS

Preferred embodiments of the present invention will be described in detail with reference to the attached drawings so as to describe the present invention in detail to such an extent that those skilled in the art to which the present invention pertains can easily implement the technical spirit of the present invention. Reference now should be made to the drawings, in which the same reference numerals are used throughout the different drawings to designate the same or similar components. Further, if in the specification, detailed descriptions of well-known functions or configurations may unnecessarily make the gist of the present invention obscure, the detailed descriptions will be omitted.

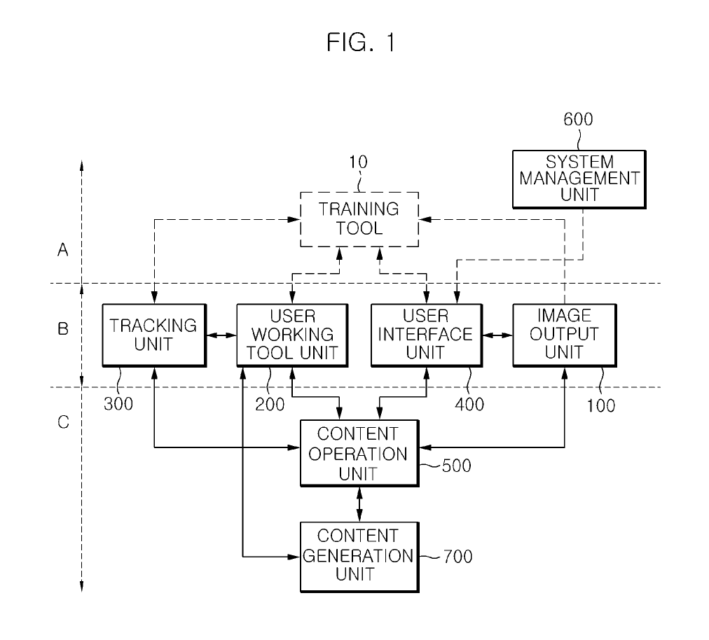

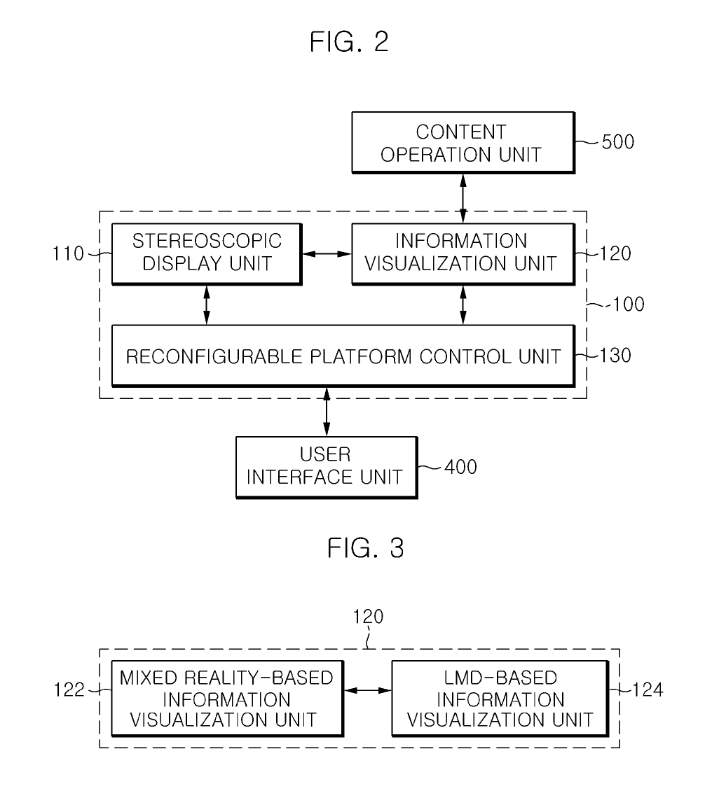

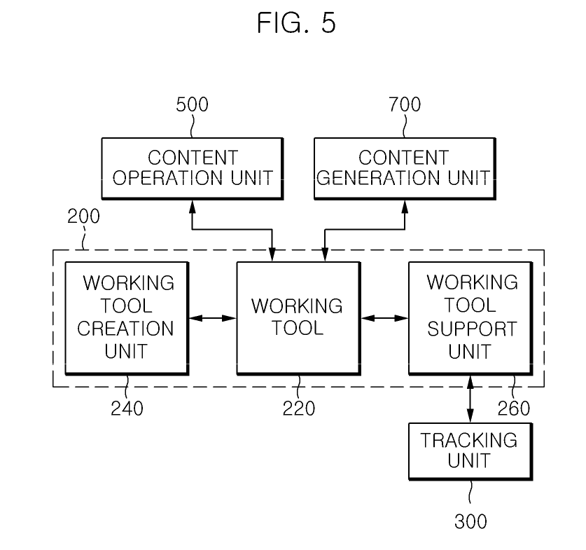

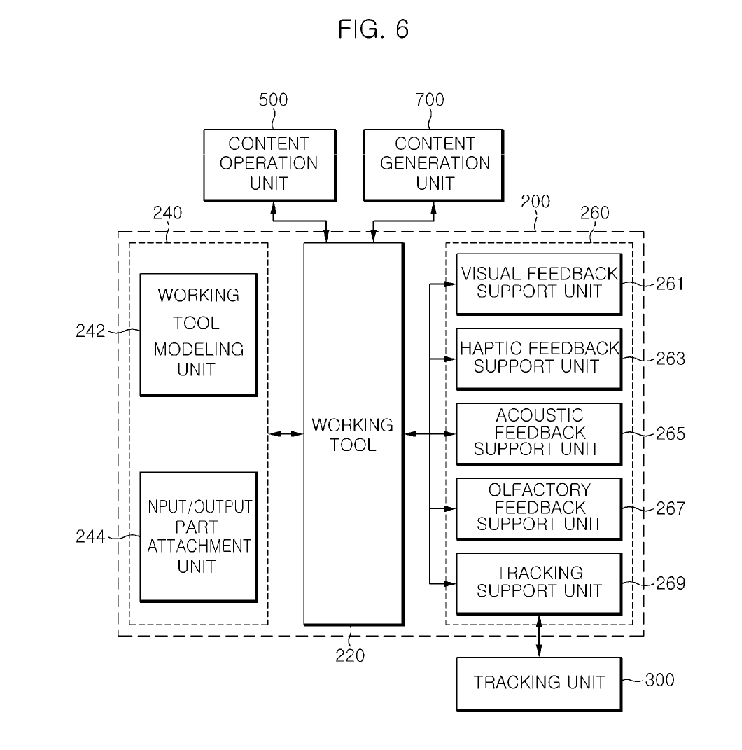

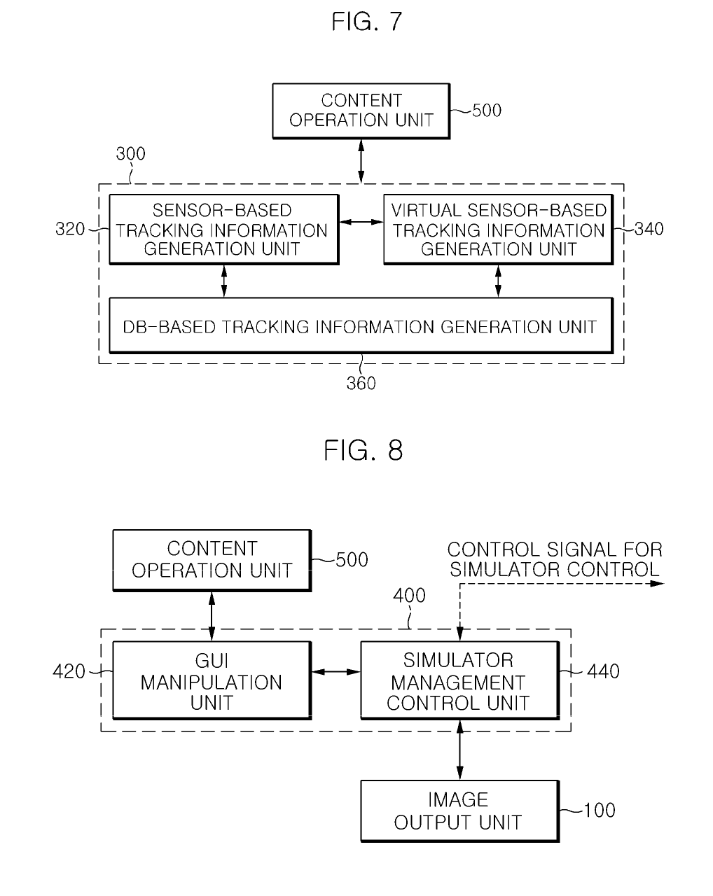

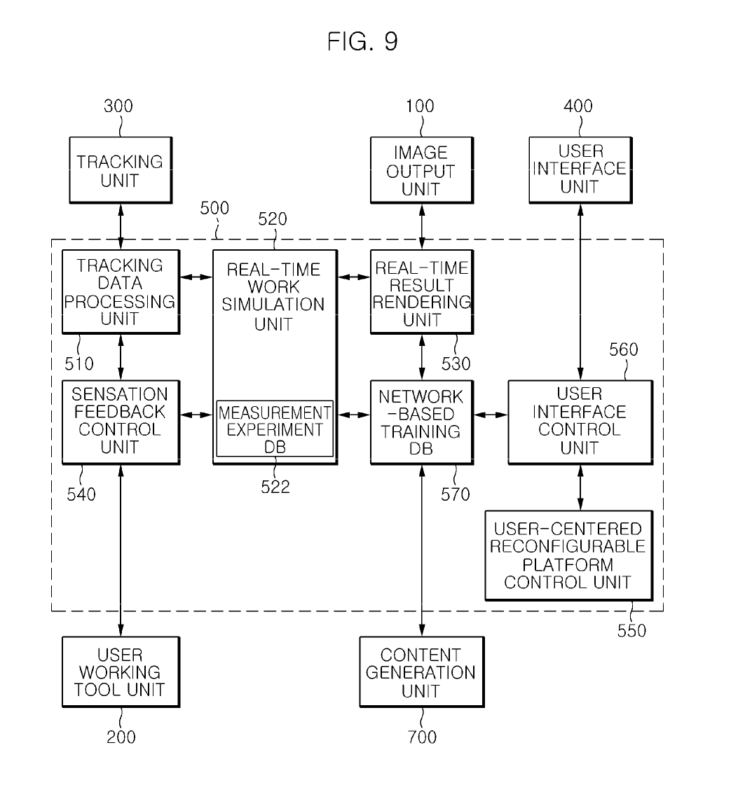

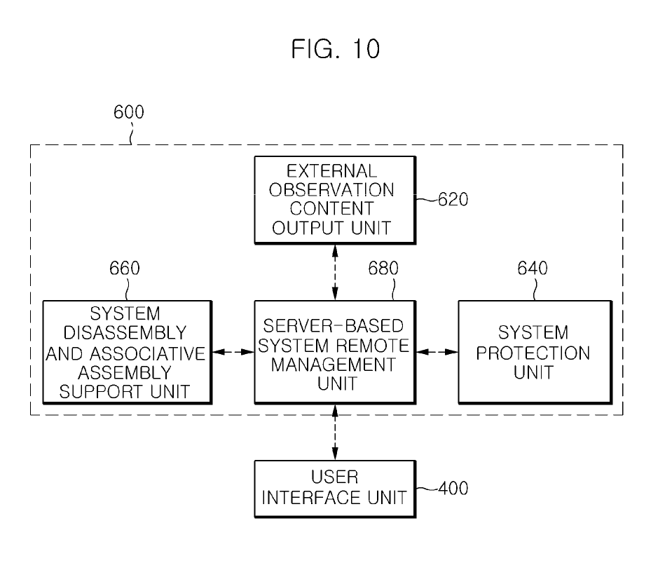

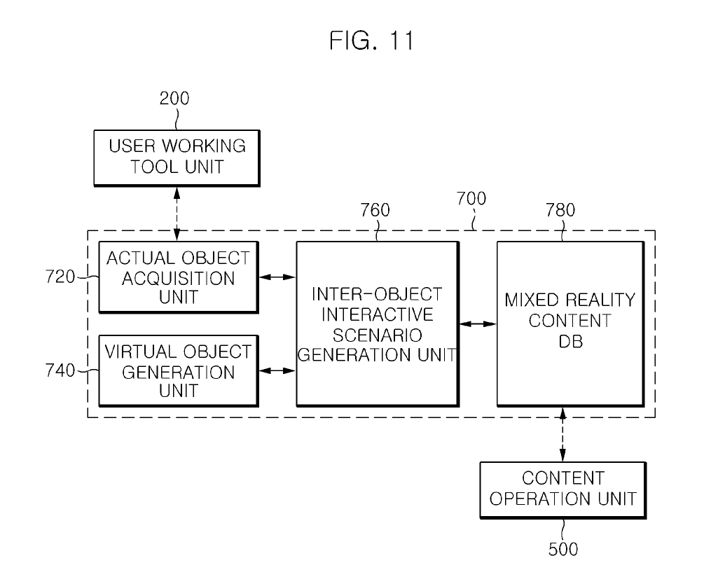

Hereinafter, a reconfigurable platform management apparatus for a virtual reality-based training simulator according to embodiments of the present invention will be described in detail with reference to the attached drawings. FIG. 1 is a diagram showing a reconfigurable platform management apparatus for a virtual reality-based training simulator according to an embodiment of the present invention, FIGS. 2 to 4 are diagrams showing the image output unit of FIG. 1, FIGS. 5 and 6 are diagrams showing the user working tool unit of FIG. 1, FIG. 7 is a diagram showing the tracking unit of FIG. 1, FIG. 8 is a diagram showing the interface unit of FIG. 1, FIG. 9 is a diagram showing the content operation unit of FIG. 1, FIG. 10 is a diagram showing the system management unit of FIG. 1, and FIG. 11 is a diagram showing the content generation unit of FIG. 1.

As shown in FIG. 1, the reconfigurable platform management apparatus for the virtual reality-based training simulator includes an image output unit 100, a user working tool unit 200, a tracking unit 300, a user interface unit 400, a content operation unit 500, a system management unit 600, and a content generation unit 700. In this case, the reconfigurable platform management apparatus for the virtual reality-based training simulator can be divided into an upper part A including the system management unit 600 and a user 10 (or a training tool), a middle part B including the image output unit 100, the user working tool unit 200, the tracking unit 300 and the user interface unit 400, and a lower part C including the content operation unit 500 and the content generation unit 700. Further, the apparatus of the present invention can be operated such that depending on consumer requirements, methods of implementing technology in the upper, middle and lower parts are differently set, methods of implementing the detailed construction of each component, which will be described later, are replaced by other similar techniques, or methods of operating the above construction with some components omitted are used.

The image output unit 100 outputs a three-dimensional (3D) image of mixed reality content used for the work training of a user. In this case, the image output unit 100 provides a stereoscopic image of mixed reality content (that is, training content provided for the work training of the user) converted into a format suitable for the user's physical condition and a work environment using a fully immersive technique. For this operation, as shown in FIG. 2, the image output unit 100 includes a stereoscopic display unit 110, an information visualization unit 120, and a reconfigurable platform control unit 130.

The stereoscopic display unit 110 divides the stereoscopic image of the mixed reality content into visual images for left and right eyes, and outputs a resulting stereoscopic image. In this case, the stereoscopic display unit 110 determines the size and arrangement structure of a stereoscopic display depending on the requirements of a training scenario for the mixed reality content. Here, the stereoscopic display unit 110 includes a Liquid Crystal Display (LCD) flat stereoscopic image panel and a translucent mirror, and an optical phase delay (retarder) is disposed between the LCD flat stereoscopic image panel and the translucent mirror.

The information visualization unit 120 visualizes additional information and outputs the additional information to the stereoscopic image output from the stereoscopic display unit 110. Here, the information visualization unit 120 receives the results of rendering the additional information 160 from the content operation unit 500 and outputs the rendered results. The information visualization unit 120 transmits or receives control signals required to implement stereoscopic images and Layered Multiple Display (LMD) images to or from the content operation unit 500. In this case, as shown in FIG. 3, the information visualization unit 120 includes a mixed reality-based information visualization unit 122 for visualizing the additional information 160 and outputting the additional information to the stereoscopic image output from the stereoscopic display unit 110, and an LMD-based information visualization unit 124 for visualizing the additional information 160 and outputting the additional information 160 to the outside of the stereoscopic image output from the stereoscopic display unit 100 so that pieces of additional information 160 differentiated for a plurality of users are provided to the respective users. Here, the mixed reality-based information visualization unit 122 visualizes a fully immersive virtual environment based on a Head Mounted Display (HMD). The mixed reality-based information visualization unit 122 outputs the additional information 160 to the 3D space of the stereoscopic image, output from the stereoscopic display unit 110, on the basis of mixed reality technology.

The LMD-based information visualization unit 124 outputs image information to a marginal region of a space representation area for stereoscopic display (for example, the outside of a stereoscopic image display space). When multiple users simultaneously participate in training, the LMD-based information visualization unit 124 provides pieces of information differentiated specifically for the respective users. In this case, the LMD-based information visualization unit 124 outputs the additional information 160 using the see-through technique used in augmented reality.

The reconfigurable platform control unit 130 sets change information required to change the structures of the stereoscopic display unit 110, the mixed reality-based information visualization unit 122, and the LMD-based information visualization unit 124, based on the user's physical information and mixed reality content currently being output. That is, when each of the stereoscopic display unit 110 and the information visualization unit 120 has a physical structure (for example, size and weight) that makes it impossible for a user to carry it, the reconfigurable platform control unit 130 sets change information required to change the structures of those components with respect to spatial and temporal elements so that the structures are suitable for the requirements of the user and work scenarios. In this case, the reconfigurable platform control unit 130 sets change information including the height, rotation, distance, etc. of the stereoscopic display unit 100 on the basis of the user's physical information and the mixed reality content. The reconfigurable platform control unit 130 compares the physical height and ground pressure distribution of the user with reference values, generates change guidance information required to change the location of the image output unit 100, and transmits and outputs the generated change guidance information to the user interface unit 400. The reconfigurable platform control unit 130 compares the physical height and ground pressure distribution of the user with reference values, and then changes the location of the image output unit 100.

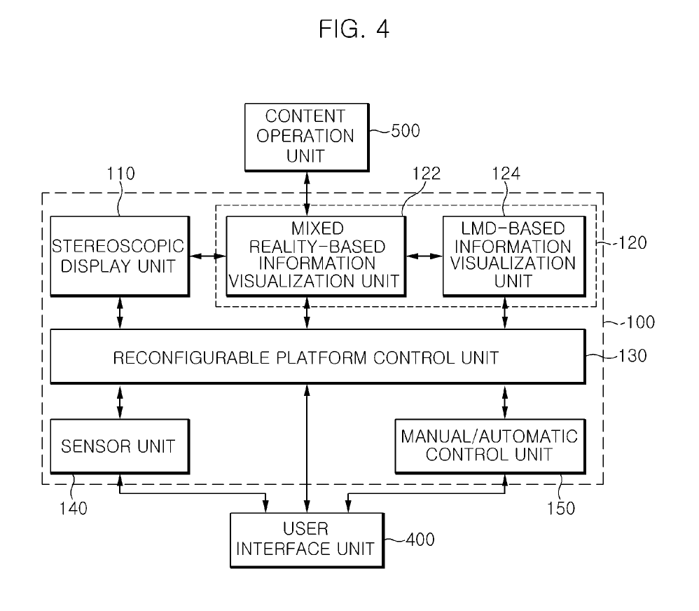

As shown in FIG. 4, the image output unit 100 may further include a sensor unit 140 and a manual/automatic control unit 150. The sensor unit 140 senses physical information about the body of the user (for example, measured values such as the height and weight, and biometric signal monitoring information such as the blood pressure, electromyogram, and electrocardiogram) so as to optimize the system for the physical characteristics of the user. The manual/automatic control unit 150 receives the information from the user interface unit 400 and changes required forms (for example, the height and rotation angle of the stereoscopic display unit 110). In this case, the manual/automatic control unit 150 changes the structures of the stereoscopic display unit 110 and the information visualization unit 120 based on at least one of the information input from the user interface unit 400, the change information input from the reconfigurable platform control unit 130, and the user's physical information sensed by the sensor unit 140.

The user working tool unit 200 generates virtual sensation feedback corresponding to sensation feedback generated based on a user's motion to the outputted stereoscopic image when working with an actual working tool 220. And the user working tool unit 200 provides the virtual sensation feedback to the user. That is, the user working tool unit 200 transfers the same sensations (that is, visual, aural, tactile and olfactory sensations) that are felt in the workplace to the user while utilizing the system by means of an interactive method identical to that of actually performing the work on the basis of the working tool 220 identical to a tool used in the actual work. In this case, when virtual object data about objects in the surrounding environment required for a training operation is needed in addition to a working tool 220 the user is holding and using in his hands in the simulation process of mixed reality content, the user working tool unit 200 models actual objects to generate virtual objects and supports the content generation unit 700 so that data about the virtual objects is used by a procedure for designing interactive scenarios and events in the content generation unit 700. For this operation, as shown in FIG. 5, the user working tool unit 200 includes at least one working tool 220, a working tool creation unit 240 for creating a plurality of working tools 220 used for a plurality of pieces of mixed reality content, and a working tool support unit 260 formed in each working tool 220 and configured to support the feedback of multiple sensations depending on the simulation of the mixed reality content.

The working tool 220 is implemented to include different shapes and functions depending on training scenarios and is configured to receive control information from the content operation unit 500 and realize the effect of the feedback of multiple sensations.

The working tool creation unit 240 generates the hardware shapes of the working tool 220 depending on training scenarios. For this, as shown in FIG. 6, the working tool creation unit 240 includes a working tool modeling unit 242 and an input/output part attachment unit 244. The working tool modeling unit 242 digitizes the actual working tool 220 used in a virtual work space, desired to be implemented in the workplace or by the simulator, by acquiring information about the 3D shape and surface material of the working tool. The input/output part attachment unit 244 is configured to add input sensors and output elements required by a relevant scenario to the inside of the working tool 220. Here, the working tool modeling unit 242 acquires the information about the 3D shape and the surface material of the working tool 220 using a manual operation based on 3D graphic modeling or using an automation tool such as a 3D scanner.

The working tool support unit 260 supports the feedback of multiple sensations for the working tool 220. For this, as shown in FIG. 6, the working tool support unit 260 includes a haptic feedback support unit 263 for transferring physical and cognitive force effects, an acoustic feedback support unit 265 for representing input/output information using sound effects, an olfactory feedback support unit 267 for providing the input/output of information using olfactory organs, a visual feedback support unit 261 for transferring feedback information related to the working tool 220 by outputting information that stimulates a visual sensation, and a tracking support unit 269 for exchanging information when acquiring part or all of the location and posture information of the working tool 220 in conjunction with the tracking unit 300.

The tracking unit 300 generates the input information of the system by tracking the states of a system user and a work environment in real time. In this case, the information about a target tracked by the tracking unit 300 is transmitted to the content operation unit 500 and is then used as the input data of a procedure for representing and simulating virtual objects. Here, the tracking unit 300 establishes a camera-based stable tracking space that includes installation locations and capturing directions for a plurality of cameras so as to track the user's motion. For this, as shown in FIG. 7, the tracking unit 300 includes a sensor-based tracking information generation unit 320, a virtual sensor-based tracking information generation unit 340, and a database (DB)-based tracking information generation unit 360. The sensor-based tracking information generation unit 320 senses at least one of location, posture, pressure, acceleration, and temperature of each of the user and the user working tool unit 200, and then tracks the user and the user working tool unit 200. The virtual sensor-based tracking information generation unit 340 generates physically sensed values using values input from the DB-based tracking information generation unit 360. The DB-based tracking information generation unit 360 simulates at regular intervals a plurality of pieces of tracking data that are stored and then generates input values which are values currently generated by the sensors.

The sensor-based tracking information generation unit 320 is a device configured to attach sensors to a specific object in a contact or non-contact manner and extract physical data such as the location, posture, pressure, acceleration, and temperature of the specific object, thus acquiring pieces of information about the specific object.

The virtual sensor-based tracking information generation unit 340 is a virtual sensor simulated by software and generates physical sensor values using the output values of the DB-based tracking information generation unit 360. In this case, the virtual sensor-based tracking information generation unit 340 may convert those sensor values into values of a third device using the input interface of the user (for example, by converting the input data values of direction keys on a keyboard into values on the specific axis of a 3D position sensor and presenting the resulting values), and then generate physical sensor values.

The DB-based tracking information generation unit 360 simulates the tracked data recorded in the DB at regular time intervals as if the tracked data were generated by the current sensors, and transfers the simulated values both to the sensor-based tracking information generation unit 320 and to the virtual sensor-based tracking information generation unit 340 as the input values thereof.

The user interface unit 400 controls the operations of the system using a simply designed graphic-based user interface. In this case, the user interface unit 400 receives preset values required to adjust parameters including at least one of the height and rotation angle of the image output unit 100 on the basis of the user's physical information and a work scenario. For this, as shown in FIG. 8, the user interface unit 400 includes a Graphic User Interface (GUI) manipulation unit 420 and a simulator management control unit 440.

The GUI manipulation unit 420 receives preset values required to set system operation setup parameters and scenario-related parameters from the user on the basis of a Graphic User Interface (GUI). The GUI manipulation unit 420 transmits the received preset values to the content operation unit 500 and outputs the current system operation setup parameters and the scenario-related parameters. In this regard, the GUI manipulation unit 420 is implemented as a device that provides both input and output as in the case of a touch screen.

The simulator management control unit 440 transmits the posture change and guidance information of the reconfigurable hardware platform to the image output unit 100 based on the conditions of a work scenario, and generates control signals required to control the simulator. That is, the simulator management controls unit 440 exchanges the posture change and guidance information of the reconfigurable hardware platform with the image output unit 100 depending on the conditions of a work scenario, and generates the control signals required to generate the simulator. In this regard, the simulator management control unit 440 includes software functions (the initiation and termination of sequential programs using a batch process) obtained by automating a series of execution processes for operating and managing the entire simulator in which a plurality of sensors, drivers, PCs, display devices and program units are integrated, and control signal generators (for power control and network communication control).

The content operation unit 500 determines the contents of the training simulator. That is, the content operation unit 500 manages a plurality of pieces of mixed reality content, detects pieces of mixed reality content used for the work training of the user from the plurality of pieces of mixed reality content, and transmits the detected mixed reality content to the image output unit 100.

For this, as shown in FIG. 9, the content operation unit 500 includes a tracking data processing unit 510, a real-time work simulation unit 520, a real-time result rendering unit 530, a sensation feedback control unit 540, a user-centered reconfigurable platform control unit 550, a user interface control unit 560, and a network-based training DB 570.

The tracking data processing unit 510 processes tracking information generated by actual and virtual tracking target entities via the tracking unit 300. That is, the tracking data processing unit 510 receives the tracking information, generated by tracking target entities, from the tracking unit 300 and then processes the tracking information.

The real-time work simulation unit 520 simulates a situation identical to reality (for example, interaction with the surrounding objects) using software (in a computation manner) on the basis of a workplace scenario that uses the simulator. For this, the real-time work simulation unit 520 is designed based on a measurement experiment DB 522 obtained from measurement experiments made in the actual workplace in order to drive an optimized real-time virtual simulation in consideration of the computational processing abilities of computer hardware systems and software algorithms that constitute the simulator.

The real-time work simulation unit 520 supports a network-based cooperative work environment in preparation for the case where there are various work conditions and a plurality of users participates in training. The real-time work simulation unit 520 includes a network-based training DB 570 to simulate workplace scenarios using previously calculated training-related information or information related to training that was conducted before.

The real-time work simulation unit 520 receives a training scenario, previously produced by the content generation unit 700, and information about interaction with surrounding objects as input, and simulates the interactive relationship between the user and virtual objects in real time.

The real-time result rendering unit 530 renders the results of the simulation performed by the real-time work simulation unit 520 and outputs the rendered results to the image output unit 100. That is, the real-time result rendering unit 530 renders the results of the simulation performed by the real-time work simulation unit 520, and transmits and outputs the rendered results to the image output unit 100.

The sensation feedback control unit 540 generates multi-sensation feedback control signals corresponding to the results of the simulation performed by the real-time work simulation unit 520 and transmits the multi-sensation feedback control signals to the user working tool unit 200. That is, the sensation feedback control unit 540 outputs the results of the simulation in the form of an event and transfers control information to the user working tool unit 200 in order to transfer a variety of pieces of information to the user via the working interface and the output display device depending on the scenarios used by the simulator. In this case, the sensation feedback control unit 540 generates multi-sensation feedback control signals (for the display device and output mechanisms related to visual, aural, tactile and olfactory sensations) which are synchronized with the real-time result rendering unit 530 on the basis of the results of the simulation by the real-time work simulation unit 520, and outputs the multi-sensation feedback control signals to the user working tool unit 200.

The user-centered reconfigurable platform control unit 550 processes the user's physical information (for example, body information and biometric information) collected based on user adaptive functions which are characteristics of the simulator platform presented by the present invention, situation information about training content being conducted, and hardware information about the simulator, in association with one another, and thus the change information of the platform is set.

The user interface control unit 560 transmits the change information set by the user-centered reconfigurable platform control unit 550 to the user interface unit. That is, the user interface control unit 560 processes the collection of related information and the transfer of change information via the user interface unit 400 on the basis of the change information set by the user-centered reconfigurable platform control unit 550.

The network-based training DB 570 stores information related to various work environments generated by the content generation unit 700. That is, the network-based training DB 570 stores a plurality of pieces of mixed reality content corresponding to the plurality of work environments generated by the content generation unit 700.

The system management unit 600 manages and maintains the simulator. For this, as shown in FIG. 10, the system management unit 600 includes an external observation content output unit 620, a system protection unit 640, and a system disassembly and associative assembly support unit 660. The external observation content output unit 620 outputs the progress of the simulation and the results of the simulation to the outside of the simulator so that a plurality of external observers can monitor the progress of simulated content without being interfered with by the limited work space of the simulator. The system protection unit 640 performs the installation and management of the system. The system disassembly and associative assembly support unit 660 facilitates the movement of the system and the simultaneous installation of a plurality of platforms. In this case, the system management unit 600 may further include a server-based system remote management unit 680 for transmitting or receiving control information required to control at least one of the initiation and termination of the remote control device and the system, and the setup of work conditions processed by the user interface unit 400. That is, since the simulator set forth by the present invention may include a plurality of electromagnetically controlled devices and computer systems, the system management unit 600 includes the server-based system remote management unit 680 to process a procedure for sending commands and messages so that the commands and state information can be exchanged and managed using a method of transferring procedures such as the initiation and termination of the individual systems and the setup of work conditions processed by the user interface unit 400 to the remote control device via a wired/wireless network. In this case, the server-based system remote management unit 680 may be implemented as a server constituting a server-client based software platform, such as a web server.

The content generation unit 700 generates mixed reality content which is managed by the system (that is, which is used for the work training of the user). That is, the content generation unit 700 is a part that supports carrying out work using separate authoring tool software (SW) when there is a need for interactivity using virtual models of virtual objects and actual objects required to conduct virtual training. Here, the content generation unit 700 supports the work so that a subsequent generation procedure is facilitated by using a previously provided mixed reality content DB 780 in preparation for various scenarios that may occur in the situation of the training.

The content generation unit 700 may generate and add additional information (for example, supplementary information) required to conduct the training or may immediately model an actual auxiliary object (for example, a worktable) that is dynamically added or deleted according to the situation of training, thereby allowing the additional information or the actual auxiliary object to be reflected in the processing of interactions with virtual objects (for example, collision processing, occlusion processing, etc.). In this case, the content generation unit 700 generates 3D virtual objects using a method of generating 3D virtual objects based on an augmented reality image-based modeling technique using a touch screen that includes an image acquisition camera enabling six-degree-of-freedom space tracking, or alternatively using a method by which an FMD user personally points at corner portions of an actual object using a hand interface associated with six-degree-of-freedom tracking and extracts 3D location values.

For this, as shown in FIG. 11, the content generation unit 700 includes an actual object acquisition unit 720, a virtual object generation unit 740, an inter-object interactive scenario generation unit 760, and a mixed reality content DB 780.

The actual object acquisition unit 720 receives virtual object models from the user working tool unit using one of the modeling of objects included in mixed reality content and the selection of stored objects, and then acquires actual objects. That is, the actual object acquisition unit 720 acquires actual objects using a method of immediately modeling objects included in the work environment of a user who is wearing a fully immersive display, or a method of selecting the actual objects from existing data that has been stored. In this case, the actual object acquisition unit 720 receives virtual object models from a manager (or a user) via the user working tool unit 200.

The virtual object generation unit 740 generates virtual objects corresponding to the actual objects acquired by the actual object acquisition unit using either input images or an image-based modeling technique. That is, the virtual object generation unit 740 generates virtual objects corresponding to the actual objects input from the actual object acquisition unit 720 on the basis of either images input from the camera or an image-based modeling technique using an interactive input interface device that enables six-degree-of-freedom tracking.

The inter-object interactive scenario generation unit 760 generates scenarios for the virtual objects generated by the virtual object generation unit 740. In this case, the inter-object interactive scenario generation unit 760 generates scenarios including the behavior of the virtual objects, generated by the virtual object generation unit 740, when reacting to the input of the user, the application of physical simulation to the virtual objects, the processing of collisions between the virtual objects, and the visualization of obstructions to guide the virtual objects to a safe working space, and also generates an animation conducted in accordance with input conditions.

The mixed reality content DB 780 stores the scenarios generated by the inter-object interactive scenario generation unit 760. In this case, the mixed reality content DB 780 mutually exchanges data with the DB of the content operation unit 500.

As described above, in FIGS. 1 to 11, the construction and operation of an overall model related to the core characteristics presented by the present invention have been described.

According to the present invention having the above construction, costs required to construct a training system identical to an actual work environment and consumptive costs caused by the consumption of materials for training can be reduced by replacing objects by virtual reality data, thus obtaining economic advantages thanks to cost reduction.

In particular, in the case of a virtual welding training simulator presented as an embodiment of the present invention which will be described later, elements corresponding to various working structures, that is, a training space, work preparation time, and finishing work time after training, can be more efficiently utilized, and the risk of injuring beginners with negligent accidents can be greatly reduced, thus enabling the beginners to be trained to become experienced workers.

In addition, the present invention visualizes any workplace that requires an educational and training procedure on the basis of a real-time simulation, and thus the present invention can be widely used in all fields in which scenarios are executed by users' activity.

Furthermore, the present invention reproduces the training scenarios and user actions, corresponding to an actual situation, in a fully immersive virtual space based on real-time simulations, so that users can experience education and training identical to those of the actual situation, thus minimizing the problems of negligent accidents that may occur in the actual education and training procedure.

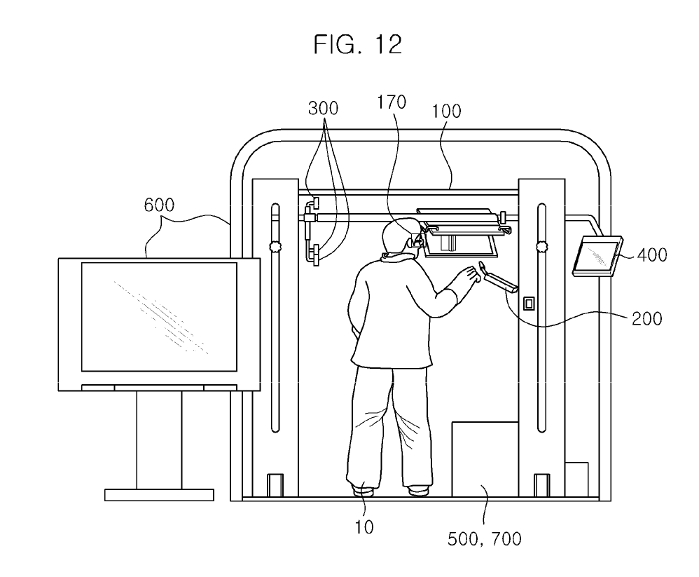

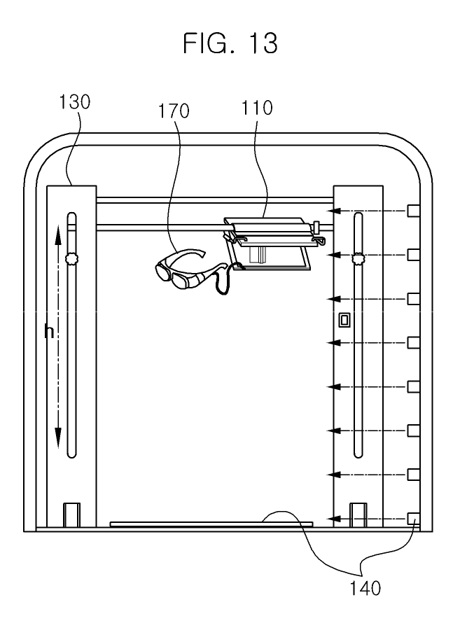

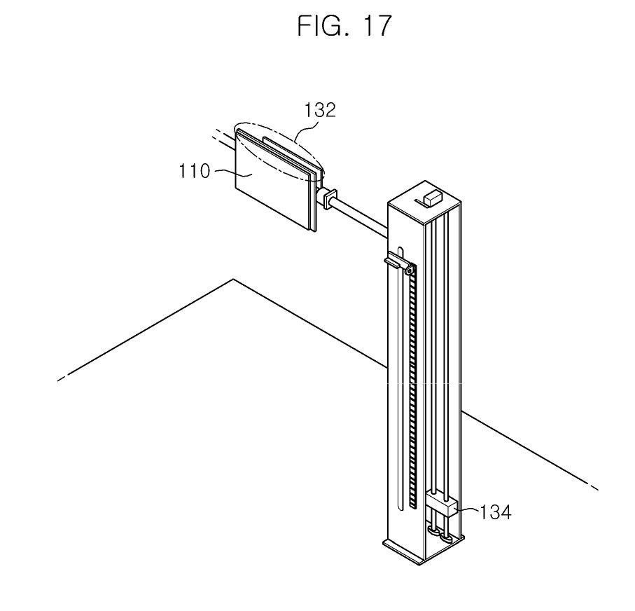

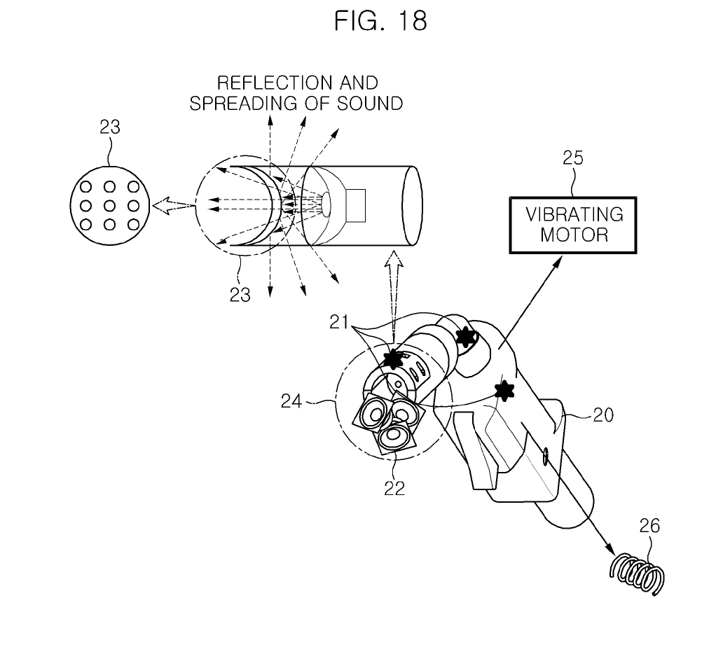

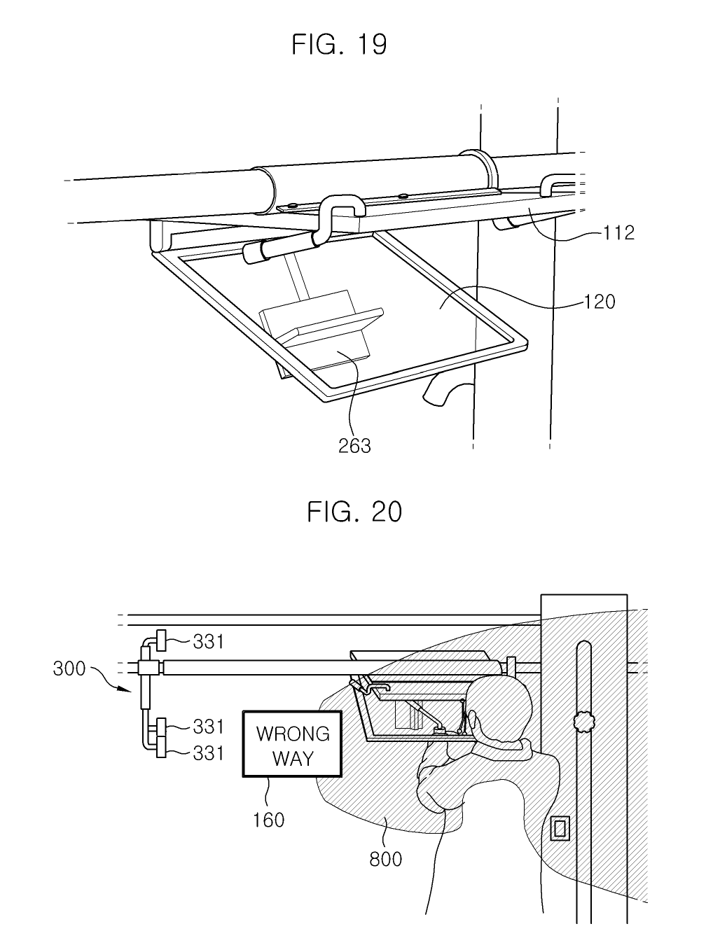

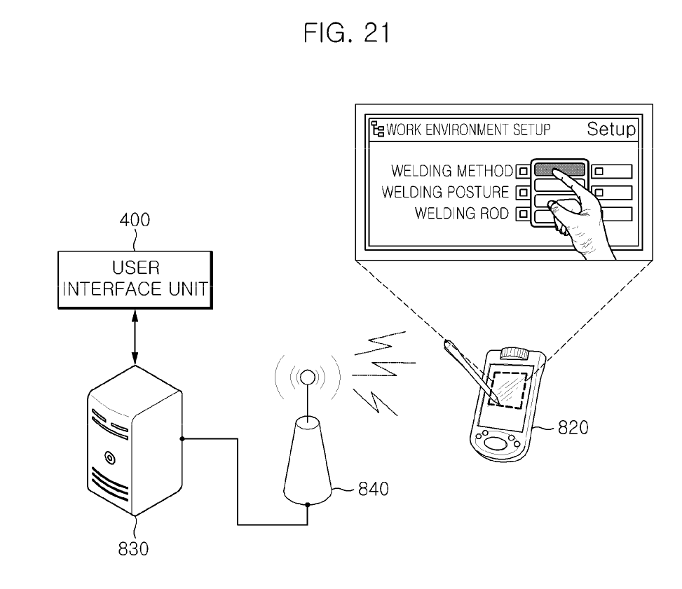

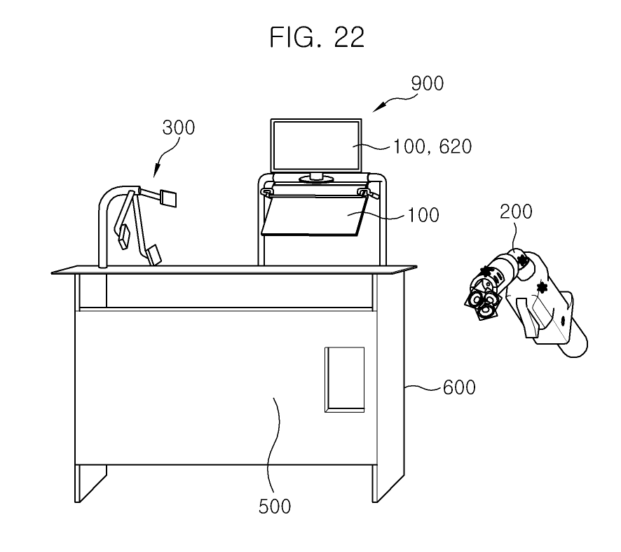

Hereinafter, embodiments of the present invention will be described to show the results of applying some functions of the present invention to the detailed and limited case of an industrial virtual welding training simulator. FIG. 12 is a diagram illustrating the construction of an industrial virtual welding training simulator according to an embodiment of the present invention, FIGS. 13 to 16 are diagrams showing the image output unit of FIG. 12, FIG. 17 is a diagram showing the reconfigurable platform control unit of FIG. 13, FIGS. 18 and 19 are diagrams showing the user working tool unit of FIG. 12, FIG. 20 is a diagram showing the tracking unit of FIG. 12, FIG. 21 is a diagram showing the content operation unit of FIG. 12, and FIG. 22 is a diagram showing the system management unit of FIG. 12.

The industrial virtual welding training simulator shown in FIG. 12 shows an example obtained by extending the construction of the prior patent “Reconfigurable device platform for a virtual reality-based training simulator and operating method thereof” (disclosed in Korean Patent Application No. 2009-0125543) to a Head Mounted Display (HMD)-based system. As shown in the drawing, when a wearing-type mixed reality display is used, the existing system can be used without change. Although the industrial virtual welding training simulator is depicted as one user (or trainee) being able to work in the simulator, two or more users can participate in training if an LMD-type mixed reality stereoscopic display is used.

As shown in FIG. 12, the industrial virtual welding training simulator includes an image output unit 100, a user working tool unit 200, a tracking unit 300, a user interface unit 400, a content operation unit 500, and a system management unit 600. The image output unit 100 is reconfigured depending on the physical information of a user and a welding training scenario. The user working tool unit 200 is basically configured to have an external appearance and a function identical to those of the working tool 220 used in the workplace and is formed in the shape of a welding torch equipped with virtual sound effects and vibrating effects. The tracking unit 300 is applied to the environment of the virtual welding training simulator in an economically optimized design. The user interface unit 400 sets up the work conditions of the welding simulator, controls changes in mechanical parts, and controls a work result analysis program. The content operation unit 500 operates all the software programs, and the system management unit 600 protects the entire system and outputs external observer target information. The present embodiment indicates the case where the stereoscopic display unit 110 and the reconfigurable platform control unit 130, among the components presented in FIG. 2, are implemented.

As shown in FIG. 13, the image output unit 100 includes a stereoscopic display unit 110, a user physical information measurement unit 140 (i.e. the sensor unit 140), and a Head-Mounted Display (HMD) for presenting multiple mixed reality stereoscopic images.

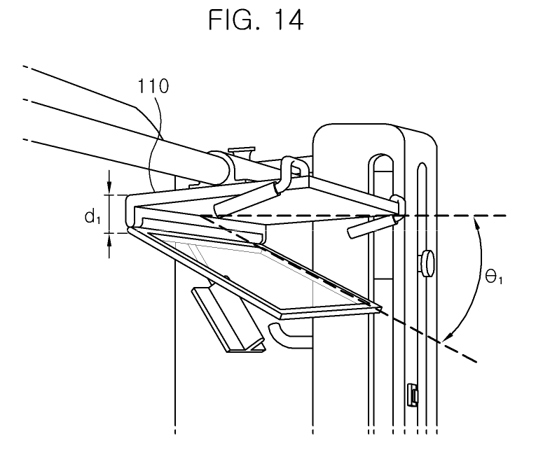

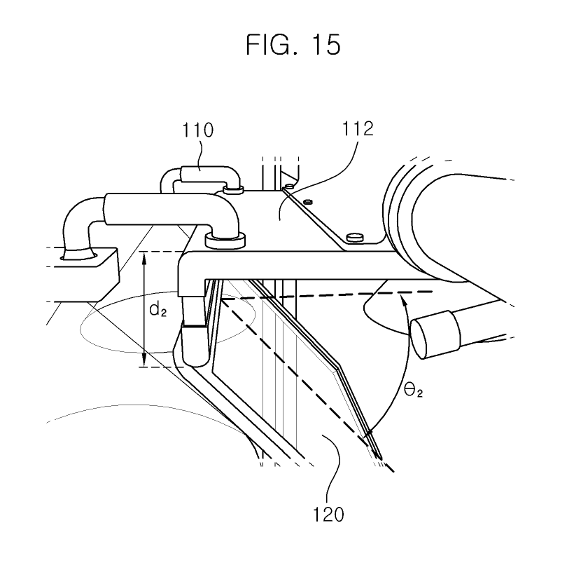

The stereoscopic display unit 110 includes a flat stereoscopic display for dividing an input image into visual images for both left and right eyes and presenting the images to a user, and a translucent reflective mirror and a filter unit (that is, the information visualization unit 120) for visualizing a stereoscopic image in the usage space of the user working tool unit 200. Accordingly, the stereoscopic display unit 110 facilitates the division and separate presentation of visual images for left and right eyes due to the diffused reflection and polarizing effects of images reflected from the flat stereoscopic display. As examples of the implementation thereof, a reflective mirror having a transmissivity of 70% and a quarter wave retarder filter were attached. That is, in the case of a normal LCD flat stereoscopic image panel and LCD shutter glasses, phase inversion occurs when images are reflected from the mirror, and thus a stereoscopic image cannot be viewed. In order solve this problem, the present invention is configured such that an optical phase delay (retarder) is installed on the mirror, so that the problem of phase inversion can be solved, and thereby a stereoscopic image reflected from the surface of the mirror can be normally viewed. Numerical values d₁, d₂, θ₁, and θ₂ of the reconfigurable platform control unit 130, the user physical information measurement unit, and the stereoscopic display unit 110 are related to the components of the reconfigurable platform control unit 130 (refer to FIGS. 14 and 15).

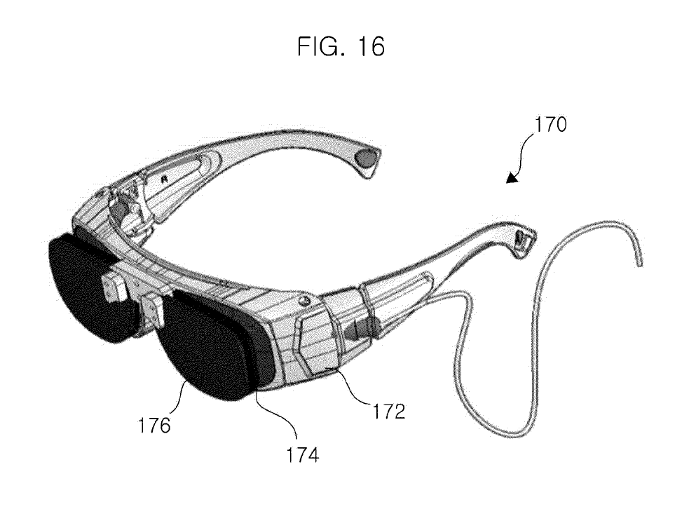

In this case, in order to overcome the disadvantages of the narrow space of the stereoscopic image unit (that is, the space is not a fully visual immersive display device, the image presentation space must be extended so that the surrounding virtual work environment can be visualized, and the function of separately visualizing private information and public information for multi-party participation is not supported), the stereoscopic display unit 110 further includes a multi-mixed reality stereoscopic image presentation HMD that includes an HMD main body, an external image transmissivity control unit, and an external stereoscopic image separation processing unit (that is, a stereoscopic image filter unit) (refer to FIG. 16). When multiple users wear such an LMD-type HMD and view the external stereoscopic display unit 110, two or more users can execute a mixed reality cooperative training scenario in the LMD environment if the refresh rate of the stereoscopic display device is raised and left and right images are rendered to n persons in a time multiplexing manner in order to visualize an external stereoscopic image in which the viewpoints of multiple persons are precisely reflected.

The user physical information measurement unit has a sensor for measuring the height of the user. The user interface unit 400 performs a procedure for setting the height value of a simulator determined according to the work scenario with reference to the height of the user, and adjusting the height steps of the simulator to conduct the designated work training (by changing the structure of the display device through the user's manual operation or by automatically moving to a designated location using a provided motor driving unit). d₁, d₂, θ₁, and θ₂ are adjusted in order to determine the height H and the rotation value π of the stereoscopic display unit 110 and to cause a stereoscopic image structure (for example, a virtual welding material block) to be seen at a designated location so that the stereoscopic display unit 110 is suited to the physical information and the selected working posture of the user. Optimal values for the respective variables are prepared in advance in a work DB, and the system outputs a guidance message to the user so as to reconfigure the stereoscopic display unit 110 using designated values. In addition, sensors for detecting relevant values (sensors for measuring rotation, height, and distance of movement) are provided in respective units, and thus the procedure for reconfiguring the structure of the system is monitored.

The reconfigurable platform control unit 130 controls the location of the stereoscopic display unit 110 on the basis of data measured by the user physical information measurement unit. In this case, the reconfigurable platform control unit 130 has, in advance, values set for the variables of the stereoscopic display unit 110 related to an upward viewing operation, a forward viewing operation, and a downward viewing operation, and also has an algorithm for changing some values in consideration of the physical conditions of the user. In the user physical information measurement unit, a pressure distribution measurement sensor installed on the bottom of the simulator tracks the state of dispersion of pressures depending on the location of the user's feet and the distribution of the weight of the user, and uses the tracked information as information required to guide the working posture and monitor the training state of the user. As shown in FIG. 17, the reconfigurable platform control unit 130 is configured in the form of a balance weight capable of controlling the rotating location (that is, π) of the stereoscopic display device only with a small amount of force, and is implemented using a balance weight and a pulley structure 134 capable of vertically moving the stereoscopic display device with a small amount of force to change the height H of the display device.

The user working tool unit 200 is configured such that on the basis of 3D model data produced by scanning a welding tool used in the actual workplace with a 3D scanning procedure, an internal arrangement space is provided to accommodate a plurality of output devices for supporting multi-sensation feedback effects, and the physical shape of a welding torch 20 which is a working tool 220 is created using 3D printing technology. As shown in FIG. 18, a plurality of sensors 21 (for example, an infrared light emitting sensor and a reflective sensor) for enabling six-degree-of-freedom (location and posture) tracking are provided in the welding torch 20 created by the user working tool unit 200. In order to simulate 3D sound effects, a plurality of micro-speakers 22 are included in the welding torch 20 to form a plurality of sound directions at an end portion of the welding torch 20 which is the location where sound is generated when actual welding is conducted. Alternatively, a spherical reflective plate 23 having a plurality of holes is attached to the front of a speaker, so that sound spreads in a radial direction. Accordingly, by merely outputting mono sound, the working tool 220 taken in the user's hands is moving, so that the location of a sound source is changed, and thus 3D spatial sound feedback can be supported.

A laser pointing output unit 24 is provided in the welding torch 20 to provide a visual feedback function for guiding the use of the working tool 220, thus enabling the location where a virtual welding bead is generated to be indicated. The visual feedback of a work distance is transferred using a method of causing an optical pattern for projection to clearly appear when a welding material is spaced apart from the end portion of the welding torch 20 by a suitable distance through the use of a lens having a focal distance identical to a suitable Contact Tip to Work Distance (CTWD) and the optical pattern for projection.

Further, a small-sized motor 25 is provided in the welding torch to exhibit vibrating effects that occur under specific welding conditions. A detachably formed passive haptic support unit is additionally mounted on the stereoscopic display unit 110, so that a physical object and an image coexist in the same space, and thus the effect of combining and visualizing the mixed reality based-realistic object and virtual image can be realized. That is, since the actual model (that is, the haptic feedback support unit 263) having a shape identical to that of a virtual welding material block is present at a corresponding location of a 3D space, the user can obtain a haptic feedback effect attributable to a physical contact between the welding torch 20 and the welding material, and thus the user can be trained more realistically. Further, in the embodiment of the present invention, a heating and cooling unit 26 capable of performing fast heating and cooling is provided in a portion of the welding torch so as to represent the sensation of heat from a flame that occurs during welding, and thus transfers the effect of heat sensation occurring during welding to the user.

The tracking unit 300 must precisely track the location and posture of the head of the user (the gaze, eye position and orientation) so as to precisely configure the space of the stereoscopic display device in which a virtual welding material is visualized and to precisely generate a stereoscopic image. For this operation, the tracking unit 300 attaches camera-based tracking sensors to tracking targets (that is, the user 10 and the welding torch 20), and defines a space, in which the targets can be stably tracked using camera-based sensor tracking devices 331 implemented using a minimum number of cameras, as a multiple camera-based stable tracking space (hereinafter referred to as a “tracking space”) 800 via a 3D graphic-based preliminary simulation calculation procedure (refer to FIG. 20). That is, in the case of the acquisition of images by the camera-based sensor tracking devices implemented as three cameras, information about the space that was input through the lenses of the cameras may be defined as a conical shape. In the case of cameras for obtaining 2D image information, image information corresponding to at least two cameras must be present so as to restore and calculate the 3D location of a target. Accordingly, the simulator system is designed such that the space in which the tracking spaces of the three cameras commonly overlap is configured to perform stable tracking, and such that a virtual welding material, a welding torch, and a marker attached to stereoscopic glasses worn by the user are included in the space. Further, in the present embodiment, a tracking space 800 is designed to use a minimum number of cameras and minimize the size of the simulator system.

The user interface unit 400 is implemented on a touch screen on the basis of a Graphic User Interface (GUI), thus enabling the input of data to be convenient. The user interface unit 400 has joints at the connection link part thereof to allow the height of the user interface unit 400 to be freely adjusted so that the interface unit 400 is disposed at a location where the user can easily manipulate it. In this case, the user interface unit 400 may provide the functions of setting work training conditions, providing the guidance of changes in devices, visualizing exemplary training guidance information, and executing a work result analysis program.

That is, when the user selects a specific work scenario by manipulating the user interface unit 400, information required to guide changes in hardware on the basis of the difference between the current state and a target state is output from the sensors attached to the inside of the simulator, and the user changes the system to the target state (or operates an automatic feeding apparatus using a motor). In this case, the user can adjust the height h and rotation value it of the display, the rotation value 9 of the reflective mirror part, and the distance d of the reflective mirror part according to the guidance of the system.

After the adjustment has been performed, the user interface unit 400 visualizes learning content related to the work guidance. After the training has been completed, training results are analyzed and evaluated by executing a work result analysis tool, and thereafter the values of a welded section and related work parameters at a desired location are investigated while the result of welding (that is, the 3D shape of a bead) is being visualized and a 3D object is being conveniently rotated using interaction on the touch screen. Further, the user interface unit 400 is connected to the network-based training DB 570 as indicated by the content operation unit 500, with the result that querying and updating the training content can be made.

The content operation unit 500 is composed of two PCs. That is, as a preliminary operation required to construct a real-time virtual welding simulator, experimental environments for actual workplace measurements are formed for various types of welding conditions, experimental samples are manufactured, and the external shape and structure of the section of a welding bead are measured, so that an experimental sample DB can be constructed. Further, from the standpoint of the supplementation of the measurement experiment DB 522, a virtual experimental sample DB is constructed using numerical models based on a welding bead generation algorithm. Optimized real-time virtual simulations are implemented using a method of teaching a neural network capable of outputting the shapes of hardened beads depending on various input values using the constructed experimental sample DB.

On the basis of the user's motion working tool unit 200 and the input of set condition values for such a training operation, the real-time work simulation unit 520 determines the external shape of a welding bead and visualizes the external shape via the real-time result rendering unit 530 while storing information in the network-based training DB 570 or retrieving the results of preliminary work under specific conditions from the DB to perform rendering. When the specific conditions are satisfied as the real-time training operation has been performed (for example, when conditions for the generation of vibrations, sounds and visual feedback events are satisfied), the multi-sensation feedback control unit 540 sends a message to the user working tool unit 200, and outputs physical effects (for example, sounds and vibrations) identical to those of work done in the workplace and work guidance information.

The user interface control unit 560 and the user-centered reconfigurable platform control unit 550 perform functions associated with the user interface unit 400. The content generation unit 700 may add additional information (for example, the additional information 160 of FIG. 20) required to carry out training using a procedure for generating the additional information, or may immediately model an actual auxiliary object (for example, a worktable) that is dynamically added or deleted according to the situation of training, thereby allowing the additional information or the actual auxiliary object to be reflected in the processing of interactions with virtual objects (for example, collision processing, occlusion processing, etc.). In this case, in order to model a worktable, 3D virtual objects are generated using a method of generating 3D virtual objects based on an augmented reality image-based modeling technique via a touch screen that includes an image acquisition camera enabling six-degree-of-freedom space tracking, or alternatively using a method by which an FMD user personally points at corner portions of an actual object using a hand interface associated with six-degree-of-freedom tracking and extracts 3D location values.

The system management unit 600 includes an output port for an external display purpose so that external observers can see the contents of an internal stereoscopic display and the contents of a touch screen monitor. Each of a plurality of welding training booths is provided with a hinge-type connection part so that the welding training booths can be connected, installed and operated. The welding training booths can selectively output internal images to external observation monitors via a monitor sharer (a KVM switch). Here, the entire surface of an external casing is made of a transparent material, so that the external casing is looked into.

As shown in FIG. 21, the remote management unit includes a wireless communication-based mobile system management device 820 so that the external user (for example, a trainer) of the training booths can easily perform the power management and system control of the virtual welding training simulator that includes electronic devices such as a plurality of PCs and electronic sensors. The wireless communication-based mobile system management device 820 outputs a GUI screen such as for menus for controlling system operation setup. In the PC part of the training simulator, a server 830 capable of processing Internet services is installed, and this is operated in conjunction with the wireless communication-based mobile system management device 820 so that the contents of the user interface unit 400 can be controlled using the web browser, thus allowing the wireless communication-based mobile system management device 820 (for example, a smart phone, a Personal Digital Assistant (PDA), or the like) to conveniently control the system. In this case, the wireless communication-based mobile system management device 820 transmits or receives data to or from the server 830 via a wireless communication device 840.

FIG. 22 is a conceptual diagram showing the implementation of a virtual welding training simulator for an educational institution according to an embodiment of the present invention.

The virtual welding training simulator for an educational institution has a structure in which some of the functions of the reconfigurable image output unit 100 are reduced, and which can be used in association with other pieces of experimental equipment (for example, the implementation of a force feedback interface using a phantom device that enables a haptic interaction) in a desktop environment. Further, such a simulator indicates a case in which the scale of the entire simulator is reduced and the system thereof is produced at lower cost, thus being able to be spread over educational institutions thanks to its movability and applicability to teaching. That is, the present system has a structure capable of changing the distance d between a rotating shaft (θ, π) and a translucent reflective mirror so that, of the functions of the above-described virtual welding training simulator, some operations such as a forward (middle) viewing operation and downward viewing operation, other than an upward viewing operation, are possible. The user interface unit 400 according to the present embodiment includes an external image output display 620.

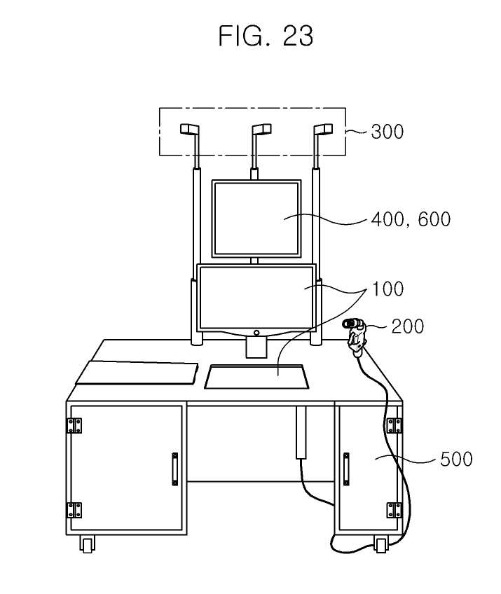

FIG. 23 is a diagram showing a picture obtained by capturing a virtual welding training simulator for an educational institution according to another embodiment of the present invention. This shows the results of removing a central reflective plate on a stereoscopic display so as to support the case where a user closely observes portions of a welding torch and a molten pool at regular intervals of several cm. In order to perform a downward viewing operation and a forward viewing operation, independent display devices for outputting stereoscopic images are provided. Further, the present training simulator has a structure in which the arrangement of the tracking system is changed from its previous location to a location that does not interfere with the working posture of the user close to the welding torch. The individual components shown in the drawing are identical to those described above.

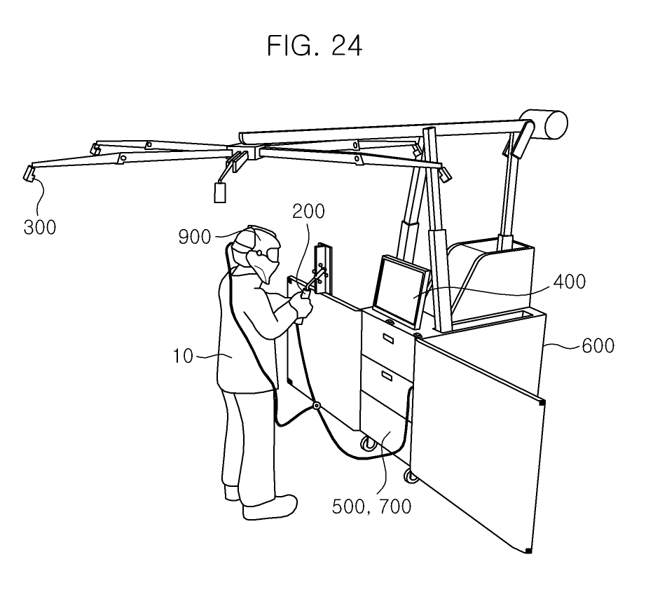

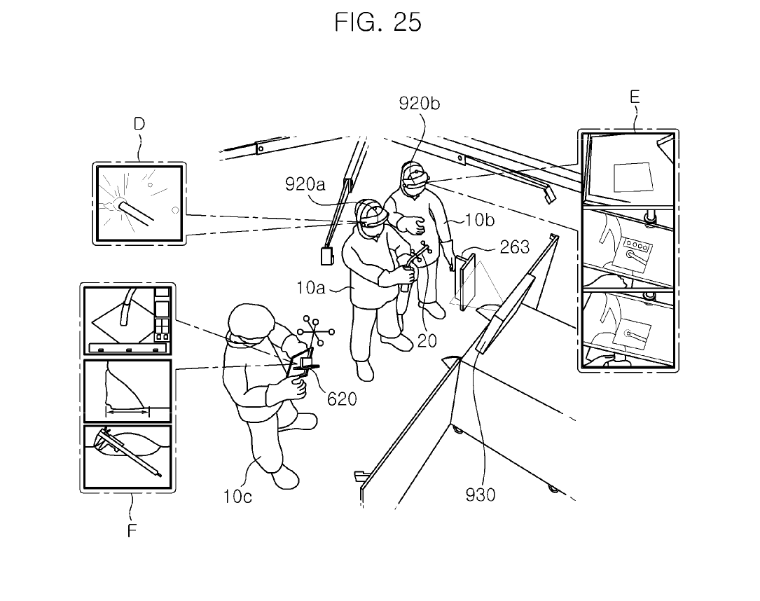

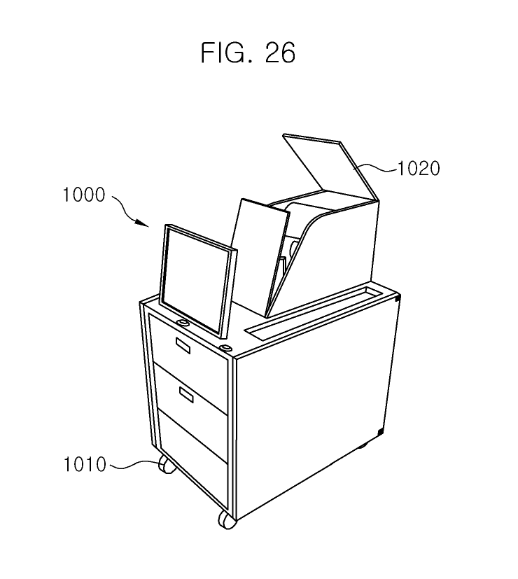

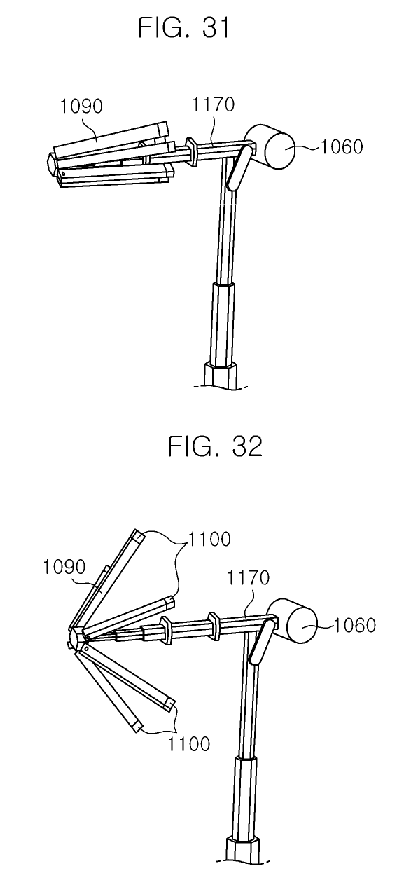

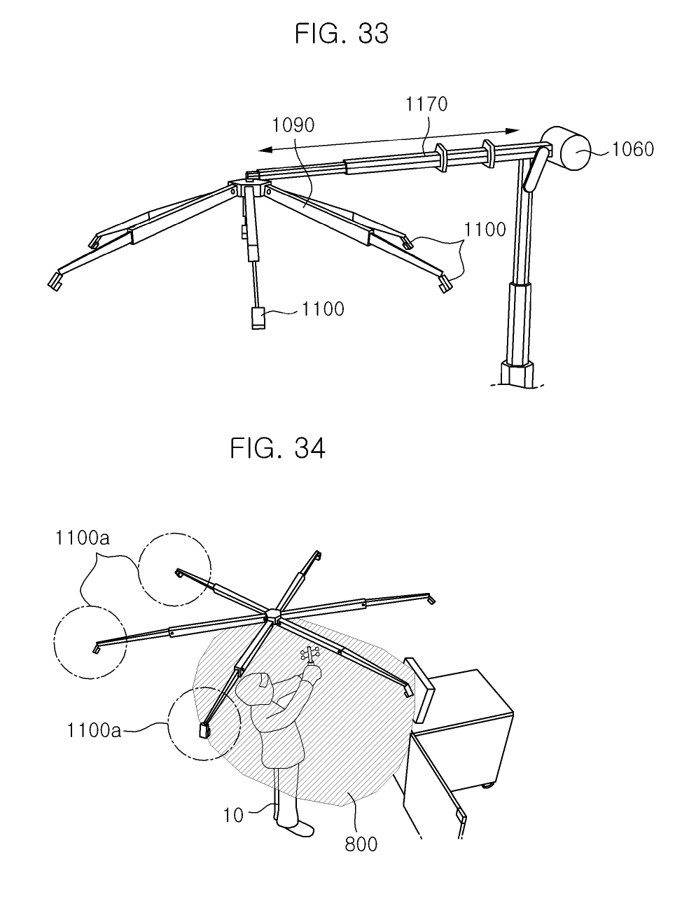

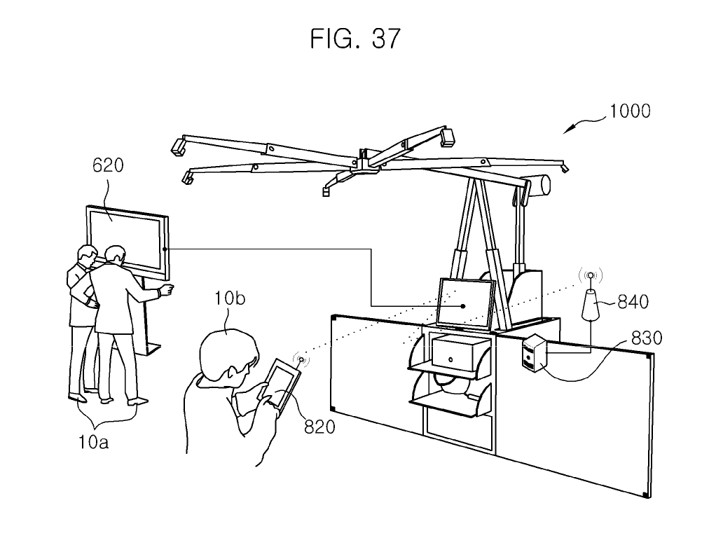

Hereinafter, embodiments of the present invention will be described to show the results of applying some functions of the present invention to the detailed and limited case of an FMD-based virtual welding training simulator. FIG. 24 is a conceptual diagram showing an FMD-based virtual welding training simulator according to an embodiment of the present invention. FIG. 25 is a diagram showing an example of the utilization of the image output unit and the LMD-supporting FMD extension version of FIG. 24, FIGS. 26 to 33 are conceptual diagrams showing the reconfigurable installation frame structure and the system management unit of the tracking unit of FIG. 24, FIGS. 34 to 36 are diagrams showing a camera-based tracking unit for implementing an FMD-based virtual welding training simulator, and FIG. 37 is a conceptual diagram showing an example of the utilization of the web pad-based result evaluation and system remote management unit of FIG. 24.

As shown in FIG. 24, the Field Mounted Display (FMD)-based virtual welding training simulator allows the user to feel as if he or she were immersed in the workplace because of a fully immersive display device such as an FMD 900. Such a simulator is designed in consideration of universality so that the user can be trained based on an interactive scenario using part of or the entirety of his or her body. The entire system configuration is similar to that of the above-described industrial and educational institution versions, but is characterized in that with the application of the FMD 900, a reconfigurable tracking unit 300 capable of supporting work in all directions including upper/lower, left/right and forward/backward directions and tracking any operating postures of the user is provided, and a means for outputting an evaluation table of training results and for controlling a remote system is presented.

As shown in FIG. 25, when an FMD 920 for presenting multi-mixed reality stereoscopic images is used, there can be implemented a scenario allowing a plurality of users to work in cooperation with each other while simultaneously viewing information presented on an external stereoscopic image display for presenting public information as well as visualizing an immersive environment. In the drawing, a 3D virtual stereoscopic material block 263 is a target observed in common by all users, and three participants access the training simulator through LMD-type FMD devices and pad-type displays using their own personal information. When a student 10a performs an actual welding operation using a welding torch 20 on a work target presented on an external stereoscopic display 930, an actual welding operation such as performing virtual arc welding and flame welding is visualized on an FMD 920a worn on the student 10a. At the same time, a work guidance expert 10b may select an information guidance method for guiding the work procedure to the student 10a in real time and assisting the student with the work, and present the information guidance method to the student, or may monitor the current situation of the work of the student through his or her FMD 920b in real time. Furthermore, a teacher 10c may perform the operation of adding an evaluation comment using a result analysis tool after viewing a training result table that is received in a wireless manner over a web browser while or after the training operation is conducted or has been completed. Alternatively, the completion level of the training of the student is evaluated by inspecting the section (numerical measurement) of a welding bead using a method of virtually cutting the 3D virtual stereoscopic welding material block 263 by way of the pad-type display device 620. In this case, on the FMD 920a of the student 10a, the situation of work training is visualized and displayed. On the FMD 920b of the expert 10b, real-time operation analysis and guidance information are visualized and displayed. On the FMD 920c of the teacher 10c, information about the analysis and evaluation of training results is visualized and displayed.

The external appearance features of the FMD-based virtual welding training simulator are that an FMD-type movable wearing-type mobile display, a system operation unit and a tracking unit capable of tracking the motion of the whole body of the user are integrated into a single unit, so that the training simulator is designed to be reducibly reconfigured or extensively installed, thus facilitating the movement and maintenance of the system. Hereinafter, the development procedure of the system will be described in detail with reference to FIGS. 26 to 30.

As shown in FIG. 26, after a caster unit 1010 for moving and fixing an FMD-based virtual welding training simulator 1000 has been fixed, a protection cover 1020 is opened to develop (extend) and install the system.

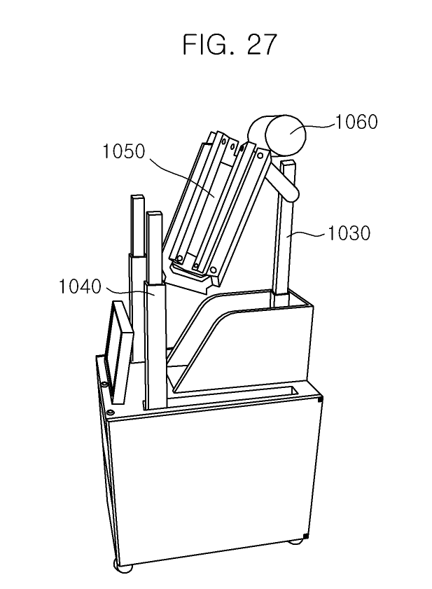

Thereafter, as shown in FIG. 27, the main support 1030 of a camera frame 1050 is extended, a sub-support 1040 providing stability is extended, and a center-of-gravity weight 1060 is used to adjust the balance of the camera frame 1050 while the camera frame 1050 which was folded in the shape of an umbrella is unfolded.

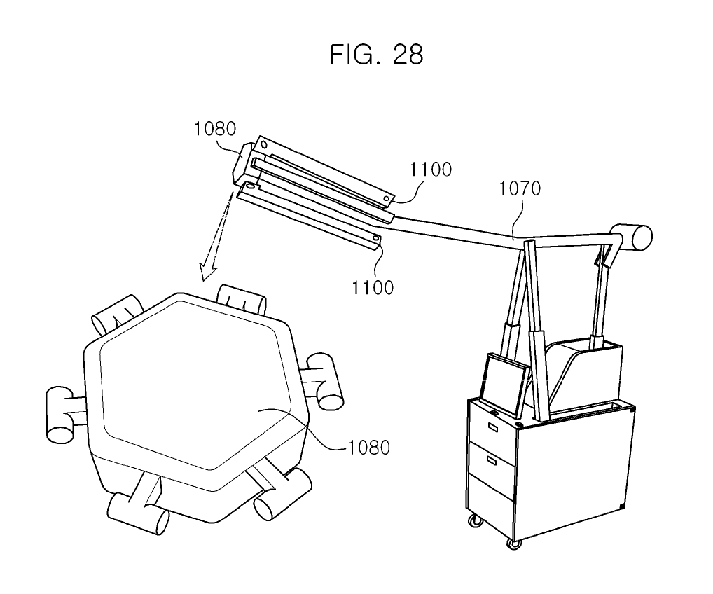

Next, as shown in FIG. 28, the camera frame 1050 is unfolded and then coupled (1070) to the sub-support 1040. In this case, a plurality of cameras 1100 is fastened to the camera frame 1050 via a camera frame center coupler 1080.

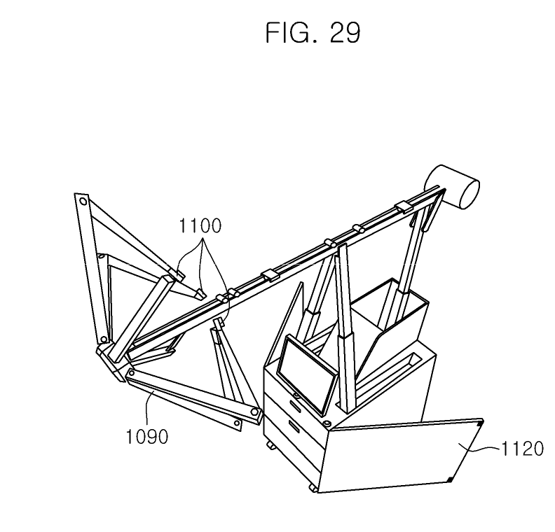

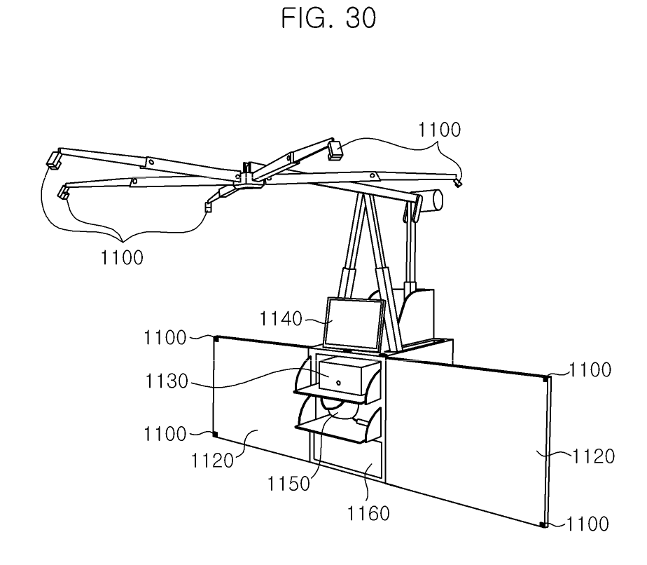

Next, as shown in FIGS. 29 and 30, the cameras 1100 inserted into camera protection spaces 1090 are deployed and installed in the form of an umbrella. To set the installation directions (angles) of the cameras 1100, joint parts at which the camera frame is bent by preset values are used without requiring a procedure of additionally finely adjusting the angles of the cameras. A control box performing communication between the cameras 1100 and the main body of the system is provided in the camera frame center coupler 1080. Four additional cameras 1100 for extending the range of tracking of the user's operation are provided to be deployed in the form of wings 1120. In the main body of the system, there are provided a rack-mount server PC 1160 for operating software, a printer 1130, and an image display device 1140, and there is also provided a receiving part 1150 for a work interface device. In this regard, FIGS. 31 to 33 illustrate examples of the implementation of methods of extending the camera frame support 1170. That is, the drawings show that the camera frame support 1040 is configured in a multi-stage structure, and is then capable of being extended according to the location of the user.

The FMD-based virtual welding training simulator can be universally used to implement a virtual reality system. In FIGS. 34 to 36, values preset by the camera-based tracking unit are presented as examples so that they can be used for a scenario wherein the whole body operation of a user is supported.

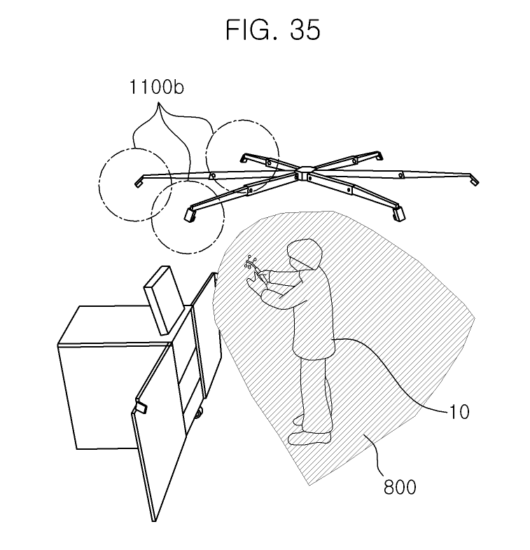

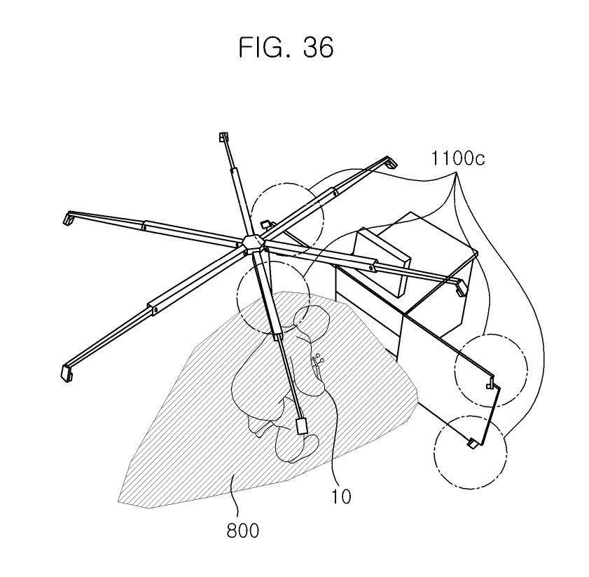

When cameras are used as tracking sensors, an operation of obtaining a plurality of intersection regions is required in consideration of the device characteristics of a single camera (for example, a viewing angle—field of view, a focal distance, etc.). The present invention is designed to easily perform this operation. Further, each camera can be replaced by another type of device having a predetermined sensing (tracking) range, and then operations desired by the present invention can be performed. For example, another type of device may be a device capable of obtaining the 3D location and posture information of a tracking target, for example, any of ultrasonic and electromagnetic tracking sensors. The number of sensors (for example, cameras) for tracking the operating range of the user may vary with the characteristics of respective devices (for example, the Field Of View (FOV) of each camera lens), and thus a tracking space 800 can be defined by providing one or more sensors. In this case, as shown in FIG. 34, three cameras 1100a installed on three camera frames arranged above the back of a user perform tracking on the basis of the case where the user assumes the posture of an upward viewing operation. As shown in FIG. 35, three cameras 1100b installed on three camera frames arranged above the front of a user perform tracking on the basis of the case where the user assumes the posture of a forward viewing operation. As shown in FIG. 36, four cameras 1100c installed on the main body of a system perform tracking on the basis of the case where a user assumes the posture of a downward viewing operation. In this case, the function of changing the angle of each camera is provided, with the result that a stable tracking space (that is, the tracking space 800) can be supported depending on the working posture of the user.

As shown in FIG. 37, an FMD-based virtual welding training simulator is provided with an external observation content output unit 620 capable of sharing the image information of the display device of each personal user (for example, images on an FMD, images on a system monitor, the evaluation screen of a teacher, etc.) for a plurality of external observers 10a. In the FMD-based virtual welding training simulator, the individual units for controlling a plurality of computer I/O devices, the tracking unit 300, and the interface devices are integrated. Accordingly, the FMD-based virtual welding training simulator provides a GUI-based system operating interface to normal users who do not get professional operating education. In this case, an operator 10b (for example, a teacher) can remotely and easily operate the system by turning on or off each device or changing image I/O channels using a method in which when the principal function of the system is selected at a conceptual level (for example, when the entire system is powered on, or when control data is input to a GUI for controlling the operations of remote equipment and a GUI for controlling simulator operations) on the basis of the system control menu using a mobile terminal device 820 (for example a smart phone, a tablet PC, a touch pad-type device, etc.) that can run a web browser, a system control command is transmitted in a wireless manner to a control device included in the main body (that is, a small-sized PC 830 with a server installed therein) and a series of batch process instructions are issued. Alternatively, the user personally issues a command for executing the operations of a keyboard and a mouse connected to the system main body, so that the operator can easily operate the system from a remote location. Further, a training result analysis tool supports a wireless print function, so that if a print command is transmitted in a wireless manner after a teacher has evaluated the results of training, the printer connected to the server outputs an evaluation table.

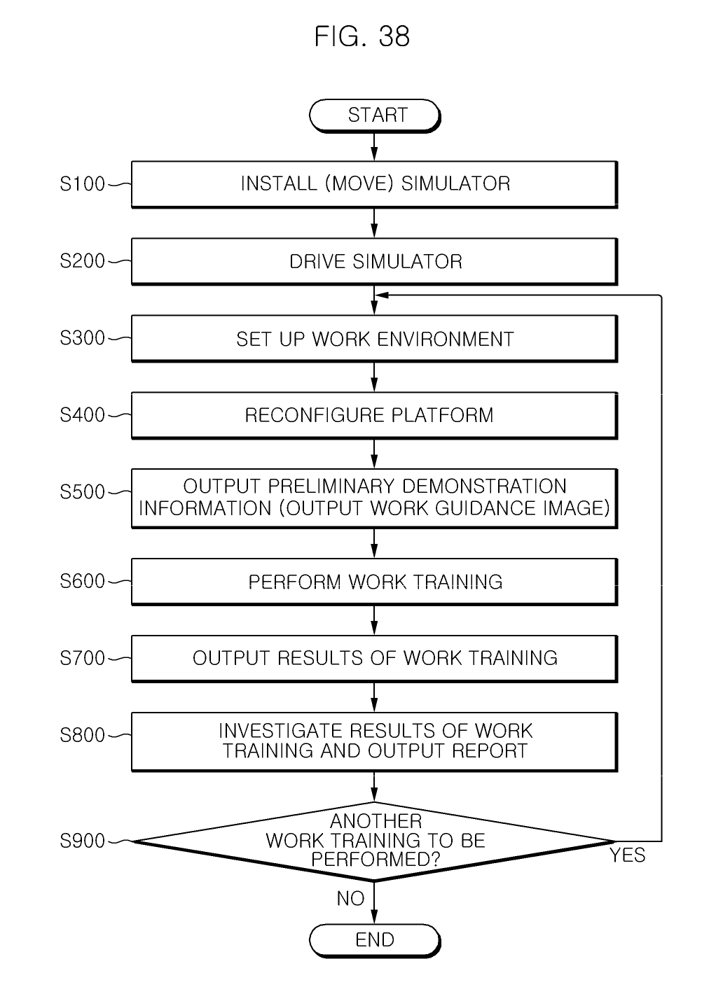

FIG. 38 is a diagram showing a method of operating the FMD-based virtual welding training simulator and an example of the installation of the simulator according to an embodiment of the present invention.

First, the FMD-based virtual welding training simulator is installed (moved) at step S100. In this case, for external observers of the simulator, a display device for simultaneously showing a monochrome image output to a stereoscopic display and an image output to a touch screen monitor is installed. Of course, in order to construct a virtual welding training simulator that is similar to a practical room for industrial welding training, the system can be configured to simultaneously control a plurality of simulators connected to each other over a wired/wireless network.

The user drives the FMD-based virtual welding training simulator at step S200. That is, the user activates the entire system and all devices using the central control switch (a power-on switch) or the mobile control device of the FMD-based virtual welding training simulator.

The FMD-based virtual welding training simulator sets up the work environment at step S300. That is, the FMD-based virtual welding training simulator outputs a work environment setup screen including a welding method, welding rod, welding material, voltage, welding posture, etc. via the user interface unit 400. The user sets up a desired work environment by selecting information output to the user interface unit 400 implemented as a touch panel. In this case, the FMD-based virtual welding training simulator may additionally extract personal information about the user. That is, the user's personal information including the height, weight, the radius of operation of the body, etc. of the user is automatically measured (or manually input), and is then applied to the work environment settings.

The FMD-based virtual welding training simulator reconfigures a platform based on the working posture of the user included in the work environment settings at step S400. In this case, the FMD-based virtual welding training simulator changes the location of the image output unit 100 (or the stereoscopic display unit 110) by vertically and rotatably moving the image output unit 100 (or the stereoscopic display unit 110) so that it is suitable for the working posture selected by the user 100. In this case, the adjustment of the location of the image output unit 100 (or the stereoscopic display unit 110) can be performed using a manual adjustment method based on the manipulation of the user or an automatic adjustment method based on the driving of a motor. Of course, a platform can be reconfigured by changing the determination of whether the image output unit 100 will output images, or by adjusting the traffic space based on the radius of the body operation of the user (that is, by changing the 3D locations of cameras using the change of a frame structure).

After the reconfiguration of the platform has been completed, the FMD-based virtual welding training simulator outputs preliminary demonstration information (that is, exemplary work guidance images) for the selected work to the user interface unit 400 at step S500. That is, the guide images are output to the working user interface unit 400. Of course, the user may wear glasses for stereoscopic images, and the stereoscopic image output unit 100 may output guidance images.

Thereafter, the FMD-based virtual welding training simulator performs work training depending on the work environment selected by the user at step S600. In this case, the user wears the glasses for stereoscopic images to use the stereoscopic display and performs actual work training using the stereoscopic display device on the basis of the virtual work guidance information projected into a 3D space. In this case, the worker conducts work training depending on a forward viewing posture (a), a downward viewing posture (b), and an upward viewing posture (c).

After the user has completed work training, the FMD-based virtual welding training simulator outputs the results of the user's work training at step S700. That is, the FMD-based virtual welding training simulator outputs the results of the user's work training to the user interface unit 400.

The FMD-based virtual welding training simulator investigates the displayed results of the user's work training and outputs a report at step S800. Thereafter, when the user desires to proceed to another work training (in the case of ‘YES’ at step S900), the FMD-based virtual welding training simulator returns to the above-described work environment setup step (that is, S300) to perform a work training procedure for another work.

As described above, when the reconfigurable platform management apparatus for the virtual reality-based training simulator is used, costs required to construct a training system identical to an actual work environment and consumptive costs caused by the consumption of materials for training can be reduced by replacing objects by virtual reality data, thus obtaining economic advantages thanks to cost reduction.

In particular, in the case of a virtual welding training simulator presented as an embodiment of the present invention which will be described later, elements corresponding to various working structures, that is, a training space, work preparation time, and finishing work time after training, can be more efficiently utilized, and the risk of injuring beginners with negligent accidents can be greatly reduced, thus enabling the beginners to be trained to become experienced workers.

In addition, the present invention visualizes any workplace that requires an educational and training procedure on the basis of a real-time simulation, and thus the present invention can be widely used in all fields in which scenarios are executed by users' activity.

Furthermore, the present invention reproduces the training scenarios and user actions, corresponding to an actual situation, in a fully immersive virtual space based on real-time simulations, so that users can experience education and training identical to those of the actual situation, thus minimizing the problems of negligent accidents that may occur in the actual education and training procedure.

As described above, although embodiments of the present invention have been described, those skilled in the art will appreciate that various modifications, additions and substitutions are possible, without departing from the scope and spirit of the invention as disclosed in the accompanying claims.

What is claimed is:

1. A reconfigurable platform management apparatus for a virtual reality-based training simulator, comprising:
an image output unit for outputting a stereoscopic image of mixed reality content that is used for work training of a user;
a user working tool unit for generating virtual sensation feedback corresponding to sensation feedback generated based on a user's motion to the outputted stereoscopic image when working with an actual working tool; and
a tracking unit for transmitting a sensing signal obtained by sensing a user's motion working tool unit to the image output unit and the user working tool unit.

2. The reconfigurable platform management apparatus of claim 1, wherein the image output unit comprises:
a stereoscopic display unit for dividing the stereoscopic image of the mixed reality content into pieces of visual information for left and right eyes and outputting a resulting stereoscopic image;
an information visualization unit for visualizing additional information and outputting the visualized additional information to the stereoscopic image output from the stereoscopic display unit; and
a reconfigurable platform control unit for, based on the user physical information and mixed reality content currently being output, setting change information required to change structures of the stereoscopic display unit and the information visualization unit.

3. The reconfigurable platform management apparatus of claim 2, wherein the information visualization unit comprises:
a mixed reality-based information visualization unit for visualizing the additional information and outputting visualized additional information to the stereoscopic image output from the stereoscopic display unit; and
a Layered Multiple Display (LMD)-based information visualization unit for visualizing the additional information and outputting visualized additional information to outside of the stereoscopic image output from the stereoscopic display unit so that pieces of additional information differentiated for a plurality of users are provided to the respective users.

4. The reconfigurable platform management apparatus of claim 3, wherein the LMD-based information visualization unit is implemented as a see-through type LMD-based display device used in augmented reality.

5. The reconfigurable platform management apparatus of claim 2, wherein the image output unit comprises:
a sensor unit for sensing the user physical information; and
a manual/automatic control unit for the changing structures of the stereoscopic display unit and the information visualization unit based on at least one of information input from a user interface unit, the change information input from the reconfigurable platform control unit, and the user physical information sensed by the sensor unit.

6. The reconfigurable platform management apparatus of claim 2, wherein the reconfigurable platform control unit sets change information such as height, rotation and distance of the stereoscopic display unit, based on the user physical information and the mixed reality content.

7. The reconfigurable platform management apparatus of claim 2, wherein the reconfigurable platform control unit compares a height and a ground pressure distribution of the user with reference values, generates change guidance information required to change a location of the image output unit, and transmits and outputs the generated change guidance information to a user interface unit.

8. The reconfigurable platform management apparatus of claim 2, wherein the reconfigurable platform control unit compares a height and a ground pressure distribution of the user with reference values, and then changes a location of the image output unit.

9. The reconfigurable platform management apparatus of claim 2, wherein the stereoscopic display unit comprises a Liquid Crystal Display (LCD) flat stereoscopic image panel and a translucent mirror, and further comprises an optical retarder between the LCD flat stereoscopic image panel and the translucent mirror.

10. The reconfigurable platform management apparatus of claim 1, wherein the user working tool unit comprises:
a working tool creation unit for creating a plurality of working tools used for a plurality of pieces of mixed reality content; and
a working tool support unit for forming in each of the working tools and supporting feedback of multiple sensations depending on simulations of the pieces of mixed reality content.

11. The reconfigurable platform management apparatus of claim 10, wherein the working tool support unit comprises:
a visual feedback support unit for outputting information that stimulates a visual sensation and transferring feedback information related to the working tool;
a haptic feedback support unit for transferring effects of physical and cognitive forces;
an acoustic feedback support unit for representing input/output information using sound effects;
an olfactory feedback support unit for providing input/output of information using an olfactory organ; and
a tracking support unit for exchanging location information and posture information of the working tool in conjunction with the tracking unit.

12. The reconfigurable platform management apparatus of claim 1, wherein the tracking unit comprises:
a sensor-based tracking information generation unit for sensing at least one of location, posture, pressure, acceleration, and temperature of each of the user and the user working tool unit, and then tracking the user and the user working tool unit;
a database(DB)-based tracking information generation unit for simulating a plurality of pieces of tracking data at regular time intervals, and generating input values which are values currently generated by sensors; and
a virtual sensor-based tracking information generation unit for generating physically sensed values using the input values generated by the DB-based tracking information generation unit.

13. The reconfigurable platform management apparatus according to claim 12, wherein the tracking unit sets a camera-based stable tracking space including installation locations and capturing directions of a plurality of cameras in order to track the user's motion.

14. The reconfigurable platform management apparatus of claim 1, wherein further comprising a user interface unit comprises:
a Graphic User Interface (GUI) manipulation unit for receiving preset values required to set system operation setup parameters and work scenario-related parameters, outputting the preset values, and transmitting the system operation setup parameters and the work scenario-related parameters to a content operation unit; and
a simulator management control unit for transmitting posture change and guidance information of a reconfigurable hardware platform to the image output unit, based on conditions of a work scenario, and generating a control signal required to control the simulator.

15. The reconfigurable platform management apparatus of claim 14, wherein the user interface unit receives preset values required to adjust parameters including at least one of a height and a rotation angle of the image output unit, based on the user physical information and the work scenario.

16. The reconfigurable platform management apparatus of claim 1, further comprising a content operation unit for managing a plurality of pieces of mixed reality content, detecting pieces of mixed reality content to be used for work training of the user from the plurality of pieces of mixed reality content, and providing the detected mixed reality content to the image output unit.

17. The reconfigurable platform management apparatus of claim 16, wherein the content operation unit comprises:
a tracking data processing unit for receiving tracking information generated by a tracking target entity from the tracking unit and processing the tracking information;
a real-time work simulation unit for simulating interaction with surrounding objects, based on a workplace scenario that utilizes the simulator;
a real-time result rendering unit for rendering results of a simulation performed by the real-time work simulation unit, and transmitting and outputting rendered results to the image output unit;
a user-centered reconfigurable platform control unit for processing situation information of the mixed reality content and the information of the simulator in association with each other, setting change information for the platform;
a user interface control unit for transmitting the change information set by the user-centered reconfigurable platform control unit to the user interface unit;
a network-based training DB for storing a plurality of pieces of mixed reality content corresponding to a plurality of work environments generated by a content generation unit; and
a multi-sensation feedback control unit for generating multi-sensation feedback control signals based on the results of the simulation performed by the real-time work simulation unit and transmitting the multi-sensation feedback control signals to the user working tool unit.

18. The reconfigurable platform management apparatus of claim 1, further comprising a system management unit comprising:
an external observation content output unit for outputting progress of a simulation and results of the simulation to outside of the simulator;
a system protection unit for performing installation and management of the system;
a system disassembly and associative assembly support unit for providing movement of the system and simultaneous installation of a plurality of platforms; and
a server-based system remote management unit for transmitting or receiving control information required to control at least one of initiation and termination of a remote control device and the system and setup of work conditions processed by the user interface unit.

19. The reconfigurable platform management apparatus of claim 1, further comprising a content generation unit for generating pieces of mixed reality content that are used for work training of the user.

20. The reconfigurable platform management apparatus of claim 19, wherein the content generation unit comprises:
an actual object acquisition unit for receiving virtual object models from the user working tool unit, using any one of modeling of objects included in the mixed reality content and selection of stored objects, and then acquiring actual objects;
a virtual object generation unit for generating virtual objects corresponding to the actual objects acquired by the actual object acquisition unit using either input images or an image-based modeling technique;
an inter-object interactive scenario generation unit for generating scenarios related to the virtual objects generated by the virtual object generation unit; and
a mixed reality content DB for storing the scenarios generated by the inter-object interactive scenario generation unit.
